(19) United States
(12) Patent Application Publication
(10) Pub. No.: US 2010/0298171 A1
(43) Pub. Date: Nov. 25, 2010

(54) APPARATUS FOR POLYMER SYNTHESIS

(75) Inventors: Mohsen Shirazi, San Jose, CA (US); Adam Pawloski, Lake Elmo, MN (US); Peter Meijles, San Jose, CA (US); Glenn H. McGall, Palo Alto, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, INC., Santa Clara, CA (US)

(21) Appl. No.: 12/786,287

(22) Filed: May 24, 2010

Related U.S. Application Data
(60) Provisional application No. 61/180,725, filed on May 22, 2009.

(51) Int. Cl. C40B 50/18; C40B 60/14

(52) U.S. Cl. 506/32; 506/40

(57) ABSTRACT

Novel processes are disclosed for the large scale preparation of arrays of polymer sequences wherein each array includes a plurality of different, positionally distinct polymer sequences having known monomer sequences. In one embodiment, two substrates are processed simultaneously in a reaction chamber, wherein the substrates are facing each other and in contact with a monomer solution. In a further embodiment, multiple rotating flow cells are used in combination with a photolysis equipment to synthesize wafers.

### RELATED APPLICATIONS

This application claims priority to Provisional Application No. 61/180,725 filed May 22, 2009, which is herein incorporated by reference in its entirety for all purposes.

### BACKGROUND OF THE INVENTION

Methods and apparatus for synthesizing a variety of different types of polymers are well known in the art. For example, the “Merrifield” method, described in Atherton et al., “Solid Phase Peptide Synthesis,” IRL Press, 1989, which is incorporated herein by reference for all purposes, has been used to synthesize peptides on a solid support.

Methods have also been developed for producing large arrays of polymer sequences on solid substrates. These large “arrays” of polymer sequences have wide ranging applications and are of substantial importance to the pharmaceutical, biotechnology and medical industries. For example, the arrays may be used in screening large numbers of molecules for biological activity, e.g., receptor binding capability. Alternatively, arrays of nucleic acid probes can be used to identify mutations in known sequences. Of particular note, is the pioneering work described in U.S. Pat. No. 5,445,934 (Fodor et al.) and U.S. Pat. No. 5,510,270 (Fodor et al.) which disclose improved methods of molecular synthesis using light directed techniques.

### SUMMARY OF THE INVENTION

Improved method for forming nucleic acid arrays, or more generally, any oligomeric arrays are provided. In a number of array fabrication technologies, the substrate on which synthesis takes place is processed individually. Once regions of the substrate have been activated, a suitable monomer (typically in solution) is contacted with the substrate for attachment to the nascent oligomer. Methods are disclosed for performing the coupling step with two substrates in one reaction chamber on a flow cell, providing for a significant reduction in the amount of reagent used per substrate and a significant reduction in the overall synthesis time per substrate per Modular Oligonucleotide Synthesizer (MOS) unit which results in an overall reduction in manufacturing cost.

In one embodiment, methods and systems of preparing a nucleic acid array on a support are provided where the synthesis includes a flow cell chamber that holds at least two substrates with surfaces to be synthesized. The substrates are activated and then placed into the reaction chamber of a flow cell, where a monomer is coupled to both surfaces of the substrates simultaneously in the reaction chamber. The activation and coupling steps are repeated until a plurality of nucleic acid arrays are formed on the surface of the substrates. Each nucleic acid array includes a plurality of different nucleic acid sequences coupled to the surface of the substrate in a different known location.

According to a further embodiment, a method of preparing a plurality of polymer arrays on the surfaces of two substrates, for example, a first surface on substrate A and a second surface on substrate B is provided. After the first and second surfaces are activated, a monomer is coupled to the first surface of substrate A and to the second surface of substrate B, simultaneously in a reaction chamber. The activating and coupling steps are repeated in different selected regions of the first and second surfaces to form a plurality of different polymer sequences in different known locations on the first and second surfaces of substrates A and B. The method then provides for the sequential activation and coupling of monomers in different selected regions of the first and second surfaces of substrates A and B to form a plurality of different polymer sequences in different known locations on the surface of the substrate, by directing an activation radiation at the first and second surfaces of the substrates. In one embodiment, the activating step is selected from the group consisting of electron beam radiation, gamma radiation, x-ray radiation, ultra-violet radiation, visible light, and infrared radiation.

In yet another embodiment, the first and second surfaces have reactive functional groups thereon. The reactive functional groups are protected by a protective group. In another embodiment, the reactive functional group is attached to the substrate via a linker. According to another embodiment, the protective group is selected from a group consisting of orthonitrobenzyl derivatives, 6-nitroveratryloxycarbonyl, 2-nitrobenzyloxycarbonyl, alpha, alpha-dimethyl-dimethoxybenzyloxy-carbonyl, o-hydroxy-alpha-methyl cinnamoyl derivatives and mixtures thereof.

In a further embodiment, a method of synthesizing polymers on substrates by coupling four substrates in a reaction chamber is provided. In another embodiment, a method for preparing a plurality of polymer arrays is provided where a solution is used to synthesize a plurality of substrates in series. For example, after the surface of at least one substrate is activated, a monomer is coupled to the surface of the substrate with a monomer solution in a reaction chamber. The activating and coupling steps are repeated in different selected regions of the surface to form a plurality of different polymer sequences in different known locations on the surface of the substrate. The monomer solution is then used to activate a surface of a different substrate by repeating the activating and coupling steps on the different substrate.

### BRIEF DESCRIPTION OF THE FIGURES

FIG. 1 schematically illustrates light directed oligonucleotide synthesis using photolithographic methods.

FIGS. 2A, 2B and 2C are flow diagrams illustrating the overall process of a substrate preparation process. FIG. 2A is a flow diagram illustrating the overall process. FIGS. 2B and 2C are flow diagrams of the synthesis steps for individual and batch processes, respectively.

FIGS. 3A and 3B show schematic illustrations of alternate flow cell systems for carrying out the combined photolysis/chemistry steps.

FIGS. 4A, 4B and 4C illustrate a flow cell system. FIGS. 4A and 4B schematically illustrate different isolated views of a flow cell incorporated into the flow cell systems of FIGS. 3A and 3B. FIG. 4C shows a schematic illustration of an integrated flow cell system including computer control and substrate translation elements.

FIGS. 5A, 5B and 5C show chemistry reactions. FIG. 5A shows the alkylation of the exocyclic amine functional group of deoxyguanosine with dimethoxytritylchloride (DMT-Cl) and subsequent coupling of a MenPOC protecting group to the 3′ hydroxyl group of a nucleoside phosphoramidite. FIG. 5B shows the synthetic route for production of Fmoc-phosphoramidites. FIG. 5C shows a synthetic route for introduction of a lipophilic substituent to the photoprotecting group MeNPOC.

FIG. 6 illustrates the active amide in various conditions in a flow cell according to an embodiment of the invention.

FIGS. 7A and 7B illustrate a flow cell system. FIG. 7A shows a schematic representation of a device including a six flow cells, for carrying out multiple parallel monomer addition steps separate from the photolysis step in light directed synthesis of oligonucleotide arrays. FIG. 7B shows a detailed view of a single flow cell.

FIGS. 8A and 8B illustrate an alternate flow cell system for carrying out the chemistry step according to an embodiment of the invention. FIG. 8A shows a schematic illustration of the alternate flow cell system. FIG. 8B shows an example of a different isolated view of the flow cell that is incorporated into the flow cell system of FIG. 8A.

FIGS. 9A, 9B, and 9C illustrate alternate gasket configurations that can be incorporated into the flow cell system of FIG. 8A according to an embodiment of the invention. FIG. 9A shows an example of an assembled flow cell. FIGS. 9B and 9C show different gasket/frame configurations that can be incorporated into the assembled flow cell of FIG. 9A.

FIGS. 10A and 10B illustrate an alternate inlet and outlet configuration that can be incorporated into the flow cell system of FIG. 8A according to an embodiment of the invention. FIG. 10A shows an example of an assembled flow cell with various possible inlet and outlet configurations. FIG. 10B shows a side view of the inlet configuration shown in FIG. 9A.

FIG. 11 shows a detailed view of an alternate flow cell system with a rotation system according to an embodiment of the invention.

### DETAILED DESCRIPTION OF THE INVENTION

Reference will now be made in detail to exemplary embodiments of the invention. While the invention will be described in conjunction with the exemplary embodiments, it will be understood that they are not intended to limit the invention to these embodiments. On the contrary, the invention is intended to encompass alternatives, modifications and equivalents, which may be included within the spirit and scope of the invention.

The invention relates to diverse fields impacted by the nature of molecular interaction, including chemistry, biology, medicine and diagnostics. Methods disclosed herein are advantageous in fields, such as those in which genetic information is required quickly, as in clinical diagnostic laboratories or in large-scale undertakings such as the Human Genome Project.

The invention has many embodiments and relies on many patents, applications and other references for details known to those of the art. Therefore, when a patent, application, or other reference is cited or repeated below, it should be understood that the entire disclosure of the document cited is incorporated by reference in its entirety for all purposes as well as for the proposition that is recited. All documents, i.e., publications and patent applications, cited in this disclosure, including the foregoing, are incorporated herein by reference in their entireties for all purposes to the same extent as if each of the individual documents were specifically and individually indicated to be so incorporated herein by reference in its entirety.

As used in this application, the singular form “a,” “an,” and “the” include plural references unless the context clearly dictates otherwise, for example, the term “an agent” includes a plurality of agents, including mixtures thereof. An individual is not limited to a human being but may also be other organisms including, but not limited to, mammals, plants, bacteria, or cells derived from any of the above.

Throughout this disclosure, various aspects of this invention can be presented in a range format. It should be understood that when a description is provided in range format, this is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

The practice of the invention may employ, unless otherwise indicated, conventional techniques and descriptions of organic chemistry, polymer technology, molecular biology (including recombinant techniques), cell biology, biochemistry, and immunology, which are within the skill of one of skill in the art. Such conventional techniques include polymer array synthesis, hybridization, ligation, and detection of hybridization using a detectable label. Specific illustrations of suitable techniques are provided by reference to the examples hereinbelow. However, other equivalent conventional procedures may also be employed. Such conventional techniques and descriptions may be found in standard laboratory manuals, such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995), Biochemistry, 4th Ed., Freeman, New York, Gait, Oligonucleotide Synthesis: A Practical Approach,(1984), IRL Press, London, Nelson and Cox (2000), Lehninger, Principles of Biochemistry, 3^{rd} Ed., W.H. Freeman Pub., New York, N.Y., and Berg et al. (2002), Biochemistry, 5^{th} Ed., W.H. Freeman Pub., New York, N.Y., all of which are herein incorporated in their entirety by reference for all purposes.

The invention may employ solid substrates, including arrays in some embodiments. Methods and techniques applicable to polymer (including protein) array synthesis have been described in U.S. patent application Ser. No. 09/536,841 (abandoned), WO Application Serial No. 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, and in PCT Application Serial Nos. PCT/US99/00730 (International Publication No. WO 99/36760) and PCT/US01/04285 (International Publication No. WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098, which are all incorporated herein by reference in their entirety for all purposes. Nucleic acid arrays are described in many of the above patents, but the same techniques are applied to polypeptide arrays.

Nucleic acid arrays that are useful in the invention include, but are not limited to, those that are commercially available from Affymetrix (Santa Clara, Calif.) under the brand name GENECHIP®. Example arrays are shown on the website at Affymetrix.com.

The invention contemplates many uses for polymers attached to solid substrates. These uses include, but are not limited to, gene expression monitoring, profiling, library screening, genotyping and diagnostics. Methods of gene expression monitoring and profiling are described in U.S. Pat. Nos. 5,800,992, 6,013,449, 6,020,135, 6,033,860, 6,040,138, 6,177,248 and 6,309,822. Genotyping methods, and uses thereof, are disclosed in U.S. patent application Ser. No. 10/442,021 (abandoned) and U.S. Pat. Nos. 5,856,092, 6,300,063, 5,858,659, 6,284,460, 6,361,947, 6,368,799, 6,333,179, and 6,872,529. Other uses are described in U.S. Pat. Nos. 5,871,928, 5,902,723, 6,045,996, 5,541,061, and 6,197,506.

The invention also contemplates sample preparation methods in certain embodiments. Prior to, or concurrent with, genotyping, the genomic sample may be amplified by a variety of mechanisms, some of which may employ PCR. (See, for example, PCR Technology: Principles and Applications for DNA Amplification, Ed. H. A. Erlich, Freeman Press, NY, N.Y., 1992; PCR Protocols: A Guide to Methods and Applications, Eds. Innis, et al., Academic Press, San Diego, Calif., 1990; Mattila et al., Nucleic Acids Res., 19:4967, 1991; Eckert et al., PCR Methods and Applications, 1:17, 1991; PCR, Eds. McPherson et al., IRL Press, Oxford, 1991; and U.S. Pat. Nos. 4,683,202, 4,683,195, 4,800,159 4,965,188, and 5,333,675, each of which is incorporated herein by reference in their entireties for all purposes. The sample may also be amplified on the array. (See, for example, U.S. Pat. No. 6,300,070 and U.S. patent application Ser. No. 09/513,300 (abandoned), all of which are incorporated herein by reference).

Other suitable amplification methods include the ligase chain reaction (LCR) (see, for example, Wu and Wallace, Genomics, 4:560 (1989), Landegren et al., Science, 241:1077 (1988) and Barringer et al., Gene, 89:117 (1990)), transcription amplification (Kwoh et al., Proc. Natl. Acad. Sci. USA, 86:1173 (1989) and WO 88/10315), self-sustained sequence replication (Guatelli et al., Proc. Nat. Acad. Sci. USA, 87:1874 (1990) and WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909 and 5,861,245) and nucleic acid based sequence amplification (NABSA). (See also, U.S. Pat. Nos. 5,409,818, 5,554,517, and 6,063,603, each of which is incorporated herein by reference). Other amplification methods that may be used are described in, for instance, U.S. Pat. Nos. 6,582,938, 5,242,794, 5,494,810, and 4,988,617, each of which is incorporated herein by reference.

Additional methods of sample preparation and techniques for reducing the complexity of a nucleic sample are described in Dong et al., Genome Research, 11:1418 (2001), U.S. Pat. Nos. 6,361,947, 6,391,592, 6,632,611, 6,872,529 and 6,958,225, and in U.S. patent application Ser. No. 09/916,135 (abandoned).

Methods for conducting polynucleotide hybridization assays have been well developed in the art. Hybridization assay procedures and conditions will vary depending on the application and are selected in accordance with known general binding methods, including those referred to in Maniatis et al., Molecular Cloning: A Laboratory Manual, 2^{nd} Ed., Cold Spring Harbor, N.Y, (1989); Berger and Kimmel, Methods in Enzymology, Guide to Molecular Cloning Techniques, Vol. 152, Academic Press, Inc., San Diego, Calif. (1987); Young and Davism, Proc. Nat'l. Acad. Sci., 80:1194 (1983). Methods and apparatus for performing repeated and controlled hybridization reactions have been described in, for example, U.S. Pat. Nos. 5,871,928, 5,874,219, 6,045,996, 6,386,749, and 6,391,623 each of which are incorporated herein by reference.

The invention also contemplates signal detection of hybridization between ligands in certain embodiments. (See, U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, U.S. patent application Ser. No. 10/389,194 (U.S. Patent Application Publication No. 2004/0012676) and PCT Application PCT/US99/06097 (published as WO 99/47964), each of which is hereby incorporated by reference in its entirety for all purposes).

The practice of the invention may also employ conventional biology methods, software and systems. Computer software products of the invention typically include, for instance, computer readable medium having computer-executable instructions for performing the logic steps of the method of the invention. Suitable computer readable medium include, but are not limited to, a floppy disk, CD-ROM/DVD/DVD-ROM, hard-disk drive, flash memory, ROM/RAM, magnetic tapes, etc. The computer executable instructions may be written in a suitable computer language or combination of several computer languages. Basic computational biology methods which may be employed in the invention are described in, for example, Setubal and Meidanis et al., Introduction to Computational Biology Methods, PWS Publishing Company, Boston, (1997); Salzberg, Searles, Kasif, (Ed.), Computational Methods in Molecular Biology, Elsevier, Amsterdam, (1998); Rashidi and Buehler, Bioinformatics Basics: Application in Biological Science and Medicine, CRC Press, London, (2000); and Ouelette and Bzevanis Bioinformatics: A Practical Guide for Analysis of Gene and Proteins, Wiley & Sons, Inc., 2^{nd} ed., (2001). (See also, U.S. Pat. No. 6,420,108).

The invention may also make use of various computer program products and software for a variety of purposes, such as probe design, management of data, analysis, and instrument operation. (See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170).

Additionally, embodiments may include methods for providing genetic information over networks such as the internet, as disclosed in, for instance, U.S. patent application Ser. Nos. 10/197,621 (U.S. Patent Application Publication No. 20030097222), 10/063,559 (U.S. Patent Application Publication No. 20020183936, abandoned), 10/065,856 (U.S. Patent Application Publication No. 20030100995, abandoned), 10/065,868 (U.S. Patent Application Publication No. 20030120432, abandoned), 10/328,818 (U.S. Patent Application Publication No. 20040002818, abandoned), 10/328,872 (U.S. Patent Application Publication No. 20040126840, abandoned), 10/423,403 (U.S. Patent Application Publication No. 20040049354, abandoned), and 60/482,389 (expired).

### I. Definitions

The term “array” or “microarray” as used herein refers to an intentionally created collection of molecules which can be prepared either synthetically or biosynthetically. The molecules in the array can be identical or different from each other. The array can assume a variety of formats, including, but not limited to, libraries of soluble molecules, and libraries of compounds tethered to resin beads, silica chips, or other solid supports. An array may include polymers of a given length having all possible monomer sequences made up of a specific set of monomers, or a specific subset of such an array. In other cases an array may be formed from inorganic materials. (See, Schultz et al., PCT application WO 96/11878).

The term “edge” as used herein refers to a boundary between two features on a surface of a substrate. The sharpness of this edge, in terms of reduced bleed over from one feature to another, is termed the “contrast” between the two features.

The term “feature” as used herein refers to a selected region on a surface of a substrate in which a given polymer sequence is contained. Thus, where an array contains, e.g., 100,000 different positionally distinct polymer sequences on a single substrate, there will be 100,000 features.

The term “Functional group” as used herein refers to a reactive chemical moiety present on a given monomer, polymer or substrate surface. Examples of functional groups include, e.g., the 3′ and 5′ hydroxyl groups of nucleotides and nucleosides, as well as the reactive groups on the nucleobases of the nucleic acid monomers, e.g., the exocyclic amine group of guanosine, as well as amino and carboxyl groups on amino acid monomers.

The term “monomer/building block” as used herein refers to a member of the set of smaller molecules which can be joined together to form a larger molecule or polymer. The set of monomers includes but is not restricted to, for example, the set of common L-amino acids, the set of D-amino acids, the set of natural or synthetic amino acids, the set of nucleotides (both ribonucleotides and deoxyribonucleotides, natural and unnatural) and the set of pentoses and hexoses. As used herein, monomer refers to any member of a basis set for synthesis of a larger molecule. A selected set of monomers forms a basis set of monomers. For example, the basis set of nucleotides includes A, T (or U), G and C. In another example, dimers of the 20 naturally occurring L-amino acids form a basis set of 400 monomers for synthesis of polypeptides. Different basis sets of monomers may be used in any of the successive steps in the synthesis of a polymer. Furthermore, each of the sets may include protected members which are modified after synthesis.

The term “oligonucleotide” or sometimes interchangeably refer by “polynucleotide” as used herein refers to a nucleic acid ranging from at least 2, or at least 8, and or at least 20 nucleotides in length or a compound that specifically hybridizes to a polynucleotide. Polynucleotides of the invention include sequences of deoxyribonucleic acid (DNA) or ribonucleic acid (RNA) which may be isolated from natural sources, recombinantly produced or artificially synthesized and mimetics thereof, such as LNA, “Locked nucleic acid”. A further example of a polynucleotide of the invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

The term “probe” as used herein refers to a surface-immobilized or free-in-solution molecule that can be recognized by a particular target. U.S. Pat. No. 6,582,908 provides an example of arrays having all possible combinations of nucleic acid-based probes having a length of 10 bases, and 12 bases or more. In one embodiment, a probe may consist of an open circle molecule, comprising a nucleic acid having left and right arms whose sequences are complementary to the target, and separated by a linker region. Open circle probes are described in, for instance, U.S. Pat. No. 6,858,412, and Hardenbol et al., Nat. Biotechnol., 21(6):673 (2003). In another embodiment, a probe, such as a nucleic acid, may be attached to a microparticle carrying a distinguishable code. Examples of encoded microparticles, methods of making the same, methods for fabricating the microparticles, methods and systems for detecting microparticles, and the methods and systems for using microparticles are described in U.S. Patent Application Publication Nos. 20080038559, 20070148599, and PCT Application No. WO 2007/081410. Each of which is hereby incorporated by reference in its entirety for all purposes. Examples of nucleic acid probe sequences that may be investigated by this invention include, but are not restricted to, those that are complementary to genes encoding agonists and antagonists for cell membrane receptors, toxins and venoms, viral epitopes, hormones (for example, opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “protecting group” as used herein refers to a material which is chemically bound to a reactive functional group on a monomer unit or polymer and which protective group may be removed upon selective exposure to an activator such as a chemical activator, or another activator, such as electromagnetic radiation or light, especially ultraviolet and visible light. Protecting groups, which are removable upon exposure to electromagnetic radiation, and in particular light, are termed “photolabile protecting groups.”

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, trenches, grooves, raised regions, pins, etched trenches, or the like. Solid supports may include any of a variety of fixed organizational support matrices. According to other embodiments, the solid support(s) will take the form of slides, solid chips, beads, resins, gels, microspheres, or other geometric configurations. (See, U.S. Pat. No. 5,744,305, for exemplary substrates). Additionally, the solid supports may be, for example, biological, nonbiological, organic, inorganic, or a combination thereof, and may be in forms including particles, strands, gels, sheets, tubing, spheres, containers, capillaries, pads, slices, films, plates, and slides depending upon the intended use.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term target is used herein, no difference in meaning is intended. A “Probe Target Pair” is formed when two macromolecules have combined through molecular recognition to form a complex.

The term “wafer” as used herein refers to a substrate having a surface to which a plurality of microarrays can be bound.

### II. Process Overview

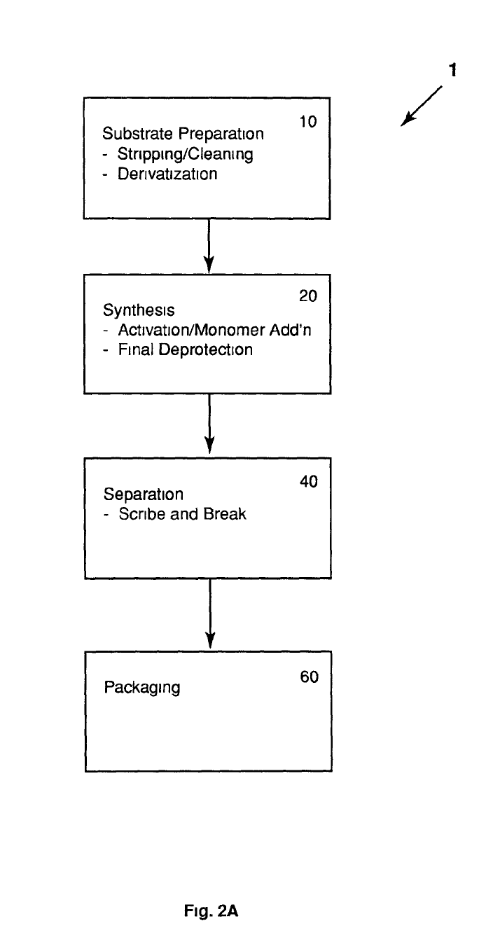

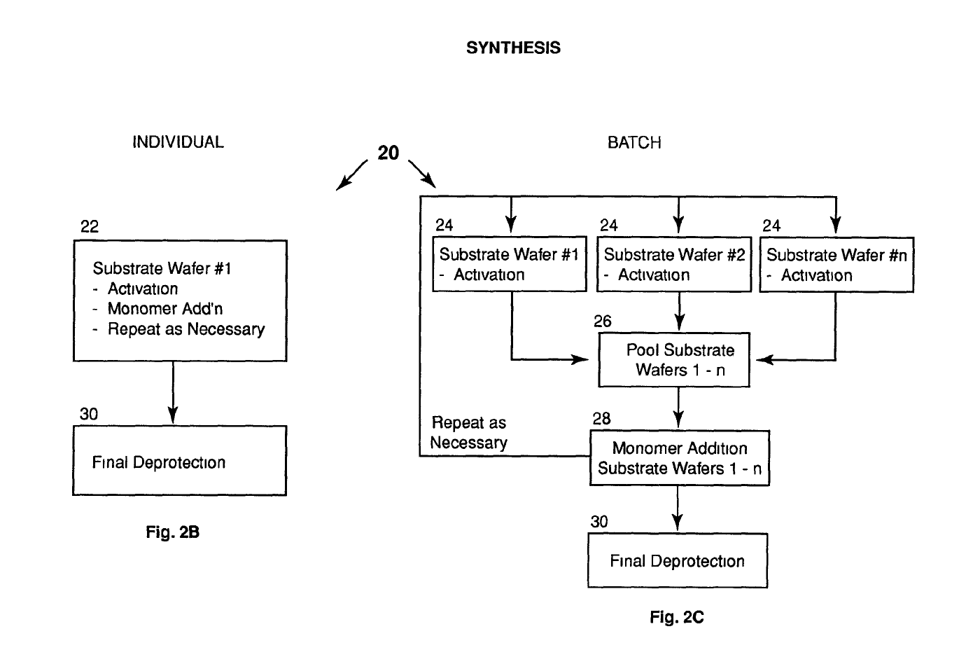

In one embodiment, processes and devices for reproducibly and efficiently preparing arrays of polymer sequences on solid substrates are provided. For example, an overall process is illustrated in FIG. 2A. Generally, the process 1 begins with a series of substrate preparation steps 10 which may include such individual processing steps as stripping cleaning and derivatization of the substrate surface to provide uniform reactive surfaces for synthesis. The polymer sequences are then synthesized on the substrate surface in the synthesis step 20.

Following polymer synthesis, the substrates are then separated into individual arrays 40, and assembled in housings, for example, cartridges, that are suitable for ultimate use 60. In alternate embodiments, methods of synthesizing polymer sequences on a substrate surface using either an individual or batch process mode are provided. A comparison of these two synthesis modes is shown in FIG. 2B. In the individual processing mode, the activation and monomer addition steps can be combined in a single unit operation 22. For example, a single wafer is placed in a flow cell system where it is first subjected to an activation step to activate selected regions of the substrate. The substrate is then contacted with a first monomer which is coupled to the activated region. Activation and coupling steps are repeated until the desired array of polymer sequences is created. The arrays of polymer sequences are then subjected to a final deprotection step 30. In one embodiment, the activation and coupling process can be performed where the substrate is in a flow cell. In another embodiment, the activation of the surface of the substrate can be performed on an equipment that is independent of the flow cell, where the coupling process can be performed.

In the batch processing mode, a number of wafers are subjected to an activating step 24. The activated wafers are then pooled 26 and subjected to a monomer addition step 28. Each wafer is then subjected individually to additional activation steps followed by pooling and monomer addition. This is repeated until a desired array of polymer sequences is formed on the wafers in a series of individual arrays. These arrays of polymer sequences on the wafers are then subjected to a final deprotection step 30. In an alternate embodiment, the number of wafers is sequentially being activated, for example, on one photolysis equipment. Then, the wafers are subject to a monomer addition step on at least 2 reaction chambers on 1 or 2 flow cells. The process will depend on the amount of time each step takes.

### III. Substrate Preparation

Supports having a surface to which arrays of nucleic acids are attached are also referred to herein as “biological chips.” According to other embodiments, small beads may be provided on the surface which may be released upon completion of the synthesis. Substrates may include planar crystalline substrates such as silica based substrates (e.g. glass, quartz, or the like), or crystalline substrates used in, e.g., the semiconductor and microprocessor industries, such as silicon, gallium arsenide and the like. The support can have the thickness of a microscope slide or glass cover slip. These substrates are generally resistant to the variety of synthesis and analysis conditions to which they may be subjected. According to another embodiment, substrates may be transparent to allow the photolithographic exposure of the substrate from either direction. Supports that are transparent to light are useful when the assay involves optical detection, as described, e.g., in U.S. patent application Ser. No. 11/243,621, which is incorporate by reference in its entirety. Other useful supports include Langmuir Blodgett film, germanium, (poly)tetrafluorethylene, polystyrene, (poly)vinylidenedifluoride, polycarbonate, gallium arsenide, gallium phosphide, silicon oxide, silicon nitride, and combinations thereof. In one embodiment, the support is a flat glass or single crystal silica surface with relief features less than about 10 Angstroms.

The surfaces on the solid supports are usually, but not always, composed of the same material as the substrate. Thus, the surface may include any number of materials, including polymers, plastics, resins, polysaccharides, silica or silica based materials, carbon, metals, inorganic glasses, membranes, or any of the above-listed substrate materials. In another embodiment, the surface will contain reactive groups, such as carboxyl, amino, and hydroxyl. In one embodiment, the surface is optically transparent and will have surface Si—OH functionalities such as are found on silica surfaces. In other embodiments, the surface will be coated with functionalized silicon compounds (see, for example, U.S. Pat. No. 5,919,523).

Silica aerogels may also be used as substrates. Aerogel substrates may be used as free standing substrates or as a surface coating for another rigid substrate support. Aerogel substrates provide the advantage of large surface area for polymer synthesis, for example, 400 to 1000 m²/gm, or a total useful surface area of 100 to 1000 cm² for a 1 cm² piece of aerogel substrate. Such aerogel substrates may generally be prepared by methods known in the art, e.g., the base catalyzed polymerization of (MeO)₄Si or (EtO)₄Si in ethanol/water solution at room temperature. Porosity may be adjusted by altering reaction condition by methods known in the art.

Individual planar substrates generally exist as wafers which can have varied dimensions.

The term “wafer” generally refers to a substantially flat sample of substrate from which a plurality of individual arrays or chips may be fabricated. The term “array” or “chip” is used to refer to the final product of the individual array of polymer sequences, having a plurality of different positionally distinct polymer sequences coupled to the surface of the substrate. The size of a wafer is generally defined by the number and nature of arrays that will be produced from the wafer. For example, more complex arrays, e.g., arrays having all possible polymer sequences produced from a basis set of monomers and having a given length, will generally utilize larger areas and thus employ larger substrates, whereas simpler arrays may employ smaller surface areas, and thus, less substrate.

Typically, the wafer will range in size of from about 1″×1″ to about 12″×12″, and will have a thickness of from about 0.5 mm to about 5 mm. Individual substrate segments which include the individual arrays, or in some cases a desired collection of arrays, are typically much smaller than the wafers, measuring from about 0.2 cm×0.2 cm 20 to about 5 cm×5 cm. In other aspects, the wafer is about 5″×5″ whereas the substrate segment is approximately 1.28 cm×1.28 cm. Although a wafer can be used to fabricate a single large substrate segment, typically, a large number of substrate segments will be prepared from a single wafer. For example, a wafer that is 5″×5″ can be used to fabricate upwards of 400 separate 5.53 mm×5.53 mm substrate segments, or up to 900 separate 3.686 mm×3,686 mm substrate segments. The number of segments prepared from a single wafer will generally vary depending upon the complexity of the array, and the desired feature size.

### A. Stripping and Rinsing

In order to ensure maximum efficiency and accuracy in synthesizing polymer arrays, it is generally desirable to provide a clean substrate surface upon which the various reactions are to take place. Accordingly, in some processing embodiments, the substrate is stripped to remove any residual dirt, oils or other fluorescent materials which may interfere with the synthesis reactions, or subsequent analytical use of the array.

The process of stripping the substrate typically involves applying, immersing or otherwise contacting the substrate with a stripping solution. Stripping solutions may be selected from a number of commercially available, or readily prepared chemical solutions used for the removal of dirt and oils, which solutions are well known in the art. In one embodiment, stripping solutions are composed of a mixture of concentrated H₂SO₄ and H₂O₂. Such solutions are generally available from commercial sources, e.g., Nanostrip™ from Cyantek Corp. After stripping, the substrate is rinsed with water and in one aspect, is then contacted with a solution of NaOH, which results in regeneration of an even layer of hydroxyl functional groups on the surface of the substrate. In this case, the substrate is again rinsed with water, followed by a rinse with HCl to neutralize any remaining base, followed again by a water rinse. The various stripping and rinsing steps may generally be carried out using a spin-rinse-drying apparatus of the type generally used in the semiconductor manufacturing industry.

Gas phase cleaning and preparation methods may also be applied to the wafers using, e.g., H₂O or O₂ plasma or reactive ion etching (RIE) techniques that are well known in the art.

### B. Derivatization

Following cleaning and stripping of the substrate surface, the surface is derivatized to provide sites or functional groups on the substrate surface for synthesizing the various polymer sequences on that surface. In particular, derivatization provides reactive functional groups, e.g., hydroxyl, carboxyl, amino groups or the like, to which the first monomers in the polymer sequence may be attached. In other aspects, the substrate surface is derivatized using silane in either water or ethanol. For example, silanes may include mono- and dihydroxyalkylsilanes, which provide a hydroxyl functional group on the surface of the substrate. Other examples include aminoalkyltrialkoxysilanes which can be used to provide the initial surface modification with a reactive amine functional group. Particularly, are 3-aminopropyltriethoxysilane and 3-aminopropyltrimethoxysilane (“APS”). Derivatization of the substrate using these latter amino silanes provides a linkage that is stable under synthesis conditions and final deprotection conditions (for oligonucleotide synthesis, this linkage is typically a phosphoramidate linkage, as compared to the phosphodiester linkage where hydroxyalkylsilanes are used). Additionally, this amino silane derivatization provides several advantages over derivatization with hydroxyalkylsilanes. For example, the aminoalkyltrialkoxysilanes are inexpensive and can be obtained commercially in high purity from a variety of sources, the resulting primary and secondary amine functional groups are more reactive nucleophiles than hydroxyl groups, the aminoalkyltrialkoxysilanes are less prone to polymerization during storage, and they are sufficiently volatile to allow application in a gas phase in a controlled vapor deposition process (See below).

Additionally, silanes can be prepared having protected or “masked” hydroxyl groups and which possess significant volatility. As such, these silanes can be readily purified by, e.g., distillation, and can be readily employed in gas-phase deposition methods of silanating substrate surfaces. After coating these silanes onto the surface of the substrate, the hydroxyl groups may be deprotected with a brief chemical treatment, e.g., dilute acid or base, which will not attack the substrate-silane bond, so that the substrate can then be used for polymer synthesis. Examples of such silanes include acetoxyalkylsilanes, such as acetoxyethyltrichlorosilane, acetoxypropyltrimethoxysilane, which may bedeprotected after application using, e.g., vapor phase ammonia and methylamine or liquid phase aqueous or ethanolic ammonia and alkylamines. Epoxyalkylsilanes may also be used, such as glycidoxypropyltrimethoxysilane which may be deprotected using, e.g., vapor phase HCl, trifluoroacetic acid or the like, or liquid phase dilute HCl.

The physical operation of silanation of the substrate generally involves dipping or otherwise immersing the substrate in the silane solution. Following immersion, the substrate is generally spun as described for the substrate stripping process, i.e., laterally, to provide a uniform distribution of the silane solution across the surface of the substrate. This ensures a more even distribution of reactive functional groups on the surface of the substrate. Following application of the silane layer, the silanated substrate may be baked to polymerize the silanes on the surface of the substrate and improve the reaction between the silane reagent and the substrate surface. Baking typically takes place at temperatures in the range of from 90° C. to 120° C. In one embodiment the temperature is at 110° C., for a time period of from about 1 minute to about 10 minutes, or for example, 5 minutes.

In alternative aspects, as noted above, the silane solution may be contacted with the surface of the substrate using controlled vapor deposition methods or spray methods. These methods involve the volatilization or atomization of the silane solution into a gas phase or spray, followed by deposition of the gas phase or spray upon the surface of the substrate, usually by ambient exposure of the surface of the substrate to the gas phase or spray. Vapor deposition typically results in a more even application of the derivatization solution than simply immersing the substrate into the solution.

The efficacy of the derivatization process, e.g., the density and uniformity of functional groups on the substrate surface, may generally be assessed by adding a fluorophore which binds the reactive groups, e.g., a fluorescent phosphoramidite such as Fluoreprime™ from Pharmacia, Corp., Fluoredite™ from Millipore, Corp. or FAM™ from ABI, and looking at the relative fluorescence across the surface of the substrate.

### IV. Synthesis

General methods for the solid phase synthesis of a variety of polymer types have been previously described. Methods of synthesizing arrays of large numbers of polymer sequences, including oligonucleotides and peptides, on a single substrate have also been described. See U.S. Pat. Nos. 5,143,854 and 5,384,261 and Published PCT Application No. WO 92/10092, each of which is incorporated herein by reference in its entirety for all purposes.

As described previously, the synthesis of oligonucleotides on the surface of a substrate may be carried out using light directed methods as described in., e.g., U.S. Pat. Nos. 5,143,854 and 5,384,261 and Published PCT Application No WO 92/10092, or mechanical synthesis methods as described in U.S. Pat. No. 5,384,261 and Published PCT Application No. 93/09668, each of which is incorporated herein by reference. In one embodiment, synthesis is carried out using light-directed synthesis methods. In particular, these light-directed or photolithographic synthesis methods involve a photolysis step and a chemistry step. The substrate surface, prepared as described herein includes functional groups on its surface. These functional groups are protected by photolabile protecting groups (“photoprotected”), also as described herein. During the photolysis step, portions of the surface of the substrate are exposed to light or other activators to activate the functional groups within those portions, i.e., to remove photoprotecting groups. The substrate is then subjected to a chemistry step in which chemical monomers that are photo protected with at least one functional group are then contacted with the surface of the substrate. These monomers bind to the activated portion of the substrate through an unprotected functional group.

Subsequent activation and coupling steps couple monomers to other preselected regions, which may overlap with all or part of the first region. The activation and coupling sequence at each region on the substrate determines the sequence of the polymer synthesized thereon. In particular, light is shown through the photolithographic masks which are designed and selected to expose and thereby activate a first particular preselected portion of the substrate. Monomers are then coupled to all or part of this portion of the substrate. The masks used and monomers coupled in each step can be selected to produce arrays of polymers having a range of desired sequences, each sequence being coupled to a distinct spatial location on the substrate which location also dictates the polymer's sequence. The photolysis steps and chemistry steps are repeated until the desired sequences have been synthesized upon the surface of the substrate.

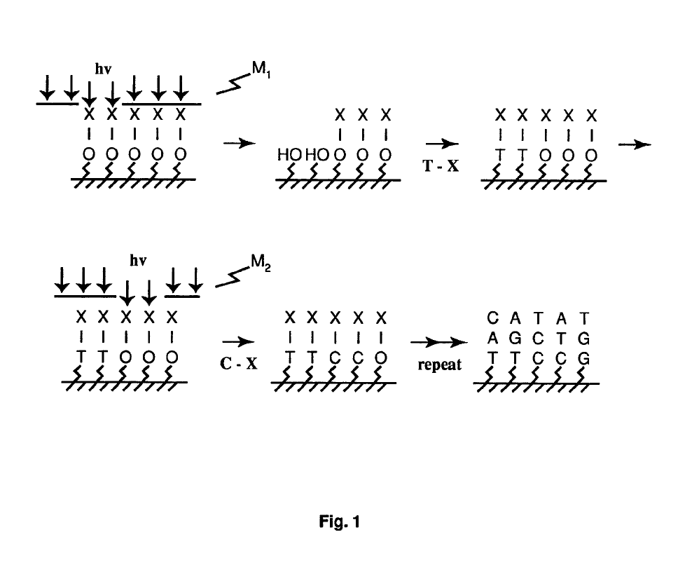

Basic strategy for light directed synthesis of oligonucleotides on a VLSIPS™ Array is outlined in FIG. 1. The surface of a substrate or solid support, modified with photosensitive protecting groups (X) is illuminated through a photolithographic mask, yielding reactive hydroxyl groups in the illuminated regions. A selected nucleotide, typically in the form of a 3′-O-phosphoramidite-activated deoxynucleoside (protected at the 5′ hydroxyl with a photosensitive protecting group), is then presented to the surface and coupling occurs at the sites that were exposed to light. Following capping and oxidation, the substrate is rinsed and the surface is illuminated through a second mask, to expose additional hydroxyl groups for coupling. A second selected nucleotide (e.g., 5′-protected, 3′-O-phosphoramidite-activated deoxynucleoside) is presented to the surface. The selective deprotection and coupling cycles are repeated until the desired set of products is obtained. See, for example, Pease et al., Proc. Natl. Acad. Sci. (1994) 91:5022-5026. Since photolithography is used, the process can be readily miniaturized to generate high density arrays of oligonucleotide probes. Furthermore, the sequence of the oligonucleotides at each site is known. Such photolithographic methods are also described in U.S. Pat. Nos. 5,143,854, 5,489,678, and Published PCT Application No. WO 94/10128 each of which is incorporated herein by reference in its entirety for all purposes. In the large scale processes of one aspect of the invention, photolithographic synthesis methods are utilized.

Using the above described methods, arrays may be prepared having all polymer sequences of a given length which are composed of a basis set of monomers. Such an array of oligonucleotides, made up of the basis set of four nucleotides, for example, would contain up to 4ⁿ oligonucleotideson its surface, where n is the desired length of the oligonucleotide probe. For an array of 8 mer or 10 mer oligonucleotides, such arrays could have upwards of about 65,536 and 1,048,576 different oligonucleotides respectively. Generally, where it is desired to produce arrays having all possible polymers of length n, a simple binary masking strategy can be used, as described in U.S. Pat. No. 5,143,854.

Alternate masking strategies can produce arrays of probes which contain a subset of polymer sequences, i.e., polymers having a given subsequence of monomers, but are systematically substituted at each position with each member of the basis set of monomers. In the context of oligonucleotide probes, these alternate synthesis strategies may be used to lay down or “tile” a range of probes that are complementary to, and span the length of a given known nucleic acid segment. The tiling strategy will also include substitution of one or more individual positions within the sequence of each of the probe groups with each member of the basis set of nucleotides. These positions are termed “interogation positions.” By reading the hybridization pattern of the target nucleic acid, one can determine if and where any mutations lie in the sequence, and also determine what the specific mutation is by identifying which base is contained within the interogation position. Tiling methods and strategies are discussed in substantial detail in U.S. patent application Ser. No. 08/143,312 (abandonded) filed Oct. 26, 1993, and incorporated herein by reference in its entirety for all purposes.

Tiled arrays may be used for a variety of applications, such as identifying mutations within a known oligonucleotide sequence or “target”. Specifically, the probes on the array will have a subsequence which is complementary to a known nucleic acid sequence, but wherein at least one position in that sequence has been systematically substituted with the other three nucleotides.

Use of photolabile protecting groups during polymer synthesis has been previously reported, as described above. In one embodiment, photolabile protecting groups generally have the following characteristics: they prevent selected reagents from modifying the group to which they are attached; they are stable to synthesis reaction conditions (that is, they remain attached to the molecule); they are removable under conditions that minimize potential adverse effects upon the structure to which they are attached; and, once removed, they do not react appreciably with the surface or surface bound oligomer. In some embodiments, liberated byproducts of the photolysis reaction can be rendered unreactive toward the growing oligomer by adding a reagent that specifically reacts with the byproduct.

The removal rate of the photolabile protecting groups generally depends upon the wavelength and intensity of the incident radiation, as well as the physical and chemical properties of the protecting group itself. In one embodiment, protecting groups are removed at a faster rate and with a lower intensity of radiation. In another embodiment, photoprotecting groups that undergo photolysis at wavelengths in the range from 300 nm to approximately 450 nm are provided.

Generally, photolabile or photosensitive protecting groups include ortho-nitrobenzyl and ortho-nitrobenzyloxycarbonyl protecting groups. The use of these protecting groups has been proposed for use in photolithography for electronic device fabrication (see, e.g., Reichmanis et al., J. Polymer Sci. Polymer Chem. Ed. (1985) 23:1-8, incorporated herein by reference for all purposes).

Examples of additional photosensitive protecting groups which may be used in the light directed synthesis methods herein described, include, e.g., 1-pyrenylmethyloxycarbonyl, α,α-dimethyl-3,5-dimethoxybenzyloxycarbonyl, 4-methoxyphenacyloxycarbonyl, 3′-methoxybenzoinyloxycarbonyl, 3′,5′-dimethoxybenzoinyl-oxycarbonyl 2′,3′-dimethoxybenzoinyl-oxycarbonyl, 2′,3′-(methylenedioxy) benzoinyloxycarbonyl, N-(5-bromo-7-nitroindolinyl)carbonyl 3,5-dimethoxybenzyloxycarbonyl, and α-(2-methyleneanthraquinone)oxycarbonyl.

In one aspect, photolabile protecting groups for protection of either the 3′ or 5′-hydroxyl groups of nucleotides or nucleic acid polymers include the o-nitrobenzyl protecting groups described in Published PCT Application No. WO 92/10092. These photolabile protecting groups include, e.g., nitroveratryloxycarbonyl (NVOC), nitropiperonyl oxycarbonyl (NPOC), α-methyl-nitroveratryloxycarbonyl (MeNVOC), α-methyl-nitropiperonyloxycarbonyl (MeNPOC), 1-pyrenylmethyloxycarbonyl (PYMOC), and the benzylic forms of each of these (i.e., o-Nitroveratryl (NV), o-Nitropiperonyl (NP), α-methyl-o-nitroveratryl (MeNV), α-methyl-o-nitropiperonyl (MeNP) and PYM, respectively), and with MeNPOC.

Protection strategies may be optimized for different phosphoramidite nucleosides to enhance synthesis efficiency. Examples of such optimized synthesis methods are reported in, e.g., U.S. patent application Ser. No. 08/445,332 (abandoned) filed May 19, 1995. Generally, these optimization methods involve selection of particular protecting groups for protection of the O⁶ group of guanosine, which can markedly improve coupling efficiencies in the synthesis of guanosine containing oligonucleotides. Similarly, selection of the appropriate protecting group for protection of the N² group of guanosine can also result in such an improvement, in absence of protection of the O⁶ group. For example, suitable protecting groups for protection of the N² group, where the O⁶ group is also protected, include, e.g., mono- or diacyl protecting groups, triarylmethyl protecting groups, e.g., 4,4′-Dimethoxytrityl (DMT) and 4-Methoxytrityl (MMT), and amidine type protecting groups, e.g., N,N-dialkylformamidines. In one aspect, protecting groups for the N₂ group include, e.g., DMT, Dimethylformamide (DMF), Phenoxyacetyl (PAC), Benzoyl (Bz) and Isobutyryl (Ibu).

Protection of the O⁶ group will generally be carried out using carbamate protecting groups such as —C(O)NX₂, where X is alkyl, or aryl; or the protecting group —CH₂CH₂Y, where Y is an electron withdrawing group such as cyano, p-nitrophenyl, or alkyl- or aryl-sulfonyl; and aryl protecting groups. In another embodiment, the O⁶ group is protected using a diphenylcarbamoyl protecting group (Diphenylcarbamoyl (DPC)).

Alternatively, improved coupling efficiencies may be achieved by selection of an appropriate protecting group for only the N² group. For example, where the N²-PAC protecting group is substituted with an Ibu protecting group, a substantial improvement in coupling efficiency is seen, even without protection of the O⁶ group.

A variety of modifications can be made to the above-described synthesis methods. For example, in some embodiments, it may be desirable to directly transfer or add photolabile protecting groups to functional groups, e.g., NH₂, OH, SH or the like, on a solid support. For these methods, conventional peptide or oligonucleotide monomers or building blocks having chemically removable protecting groups are used instead of monomers having photoprotected functional groups. In each cycle of the synthesis procedure, the monomer is coupled to reactive sites on the substrate, e.g., sites deprotected in a prior photolysis step. The protecting group is then removed using conventional chemical techniques and replaced with a photolabile protecting group prior to the next photolysis step.

A number of reagents will effect this replacement reaction. Generally, these reagents will have the following generic structure:

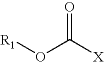

where R₁ is a photocleavable protecting group and X is a leaving group, i.e., from the parent acid HX. The stronger acids typically correspond to better leaving groups and thus, more reactive acylating agents.

Examples of suitable leaving groups include a number of derivatives having a range of properties, e.g., relative reactivity, solubility, etc. These groups generally include simple inorganic ions, i.e., halides, N₃⁻, and the like, as well as compounds having the following structures:

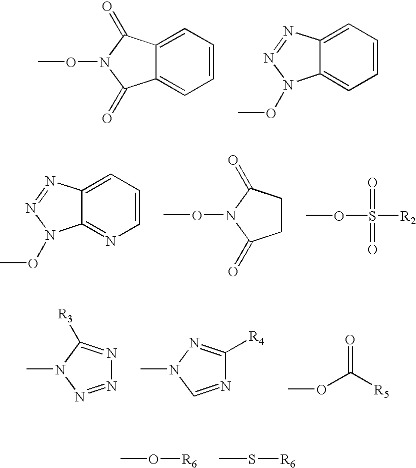

where R₂ is alkyl, substituted alkyl or aryl, R₃ is hydrogen, alkyl, thioalkyl, aryl; R₄ is an electron withdrawing group such as NO₂, SO₂—R₂, or CN; R₅ is a sterically hindered alkyl or aryl group such as adamantyl, t-butyl and the like; and R₆ is alkyl or aryl substituted with electronegative substituents. Examples of these latter leaving groups include:

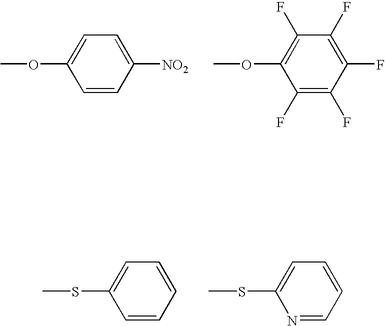

Conditions for carrying out this transfer are similar to those used for coupling reaction in solid phase peptide synthesis, or for the capping reaction in solid phase oligonucleotide synthesis. The solid phase amine, hydroxyl or thiol groups are exposed to a solution of the protecting group coupled to the leaving group, e.g., MeNPOC—X in a non-nucleophilic organic solvent, e.g., DMF, n-methylpyrollidinone (NMP), dichloromethane (DCM), Tetrahydrofuran (THF), Acetonitrile (ACN), and the like, in the presence of a base catalysts, such as pyridine, 2,6-lutidine, Triethylamine (TEA), Diiminoethylamine (DIEA) and the like. In cases where acylation of surface groups is less efficient under these conditions, nucleophilic catalysts such as Dimethylaminopyridine (DMAP), n-methylimidazole (NMI), 1-hydroxybenzotriazole (HOBT), 1-Hydroxy-7-azabenzotriazole (HOAT) and the like, may also be included to accelerate the reaction through the in situ generation of more reactive acylating agents. For example, this would typically be the case where a derivative is provided for its longer term stability in solution, but is not sufficiently reactive without the addition of one or more of the catalysts mentioned above. In one embodiment, on automated synthesizers, a reagent is chosen which can be stored for longer terms as a stable solution and then activated with the catalysts only when needed, i.e., in the flow cell system, or just prior to the addition of the reagent to the flow cell. Methods and apparatus of the Flow Cell/Reactor system have been described in U.S. Pat. Nos. 5,959,098, 6,307,042, and 6,706,875. Each of which is incorporated herein by reference in its entirety for all purposes.

In addition to the protection of amine groups and hydroxyl groups in peptide and oligonucleotide synthesis, the reagents and methods described herein may be used to transfer photolabile protecting groups directly to any nucleophilic group, either tethered to a solid support or in solution.

### A. Individual Processing

### 1. Flow Cell/Reactor System

In one embodiment, the substrate preparation process combines the photolysis and chemistry steps in a single unit operation. In this embodiment, a substrate is mounted in a flow cell during both the photolysis and chemistry or monomer addition steps. In particular, the substrate is mounted in a flow cell system that allows for the photolytic exposure of the synthesis surface of the substrate to activate the functional groups thereon. Solutions containing chemical monomers are then introduced into the flow cell system and contacted with the synthesis surface, where the monomers can bind with the active functional groups on the substrate surface. The monomer containing solution is then removed from the flow cell system, and another photolysis step is performed, exposing and activating different selected regions of the substrate surface. This process is repeated until the desired polymer arrays are created. In an alternate embodiment, a substrate is mounted in a flow cell only during the chemistry or monomer addition steps. The substrate is transferred to, for example, a photolysis equipment to perform the activation.

Flow cell systems and flow cells that are particularly suited for the combined photolysis/chemistry process include those described in, e.g., U.S. Pat. No. 5,424,186, which are incorporated herein by reference in its entirety for all purposes.

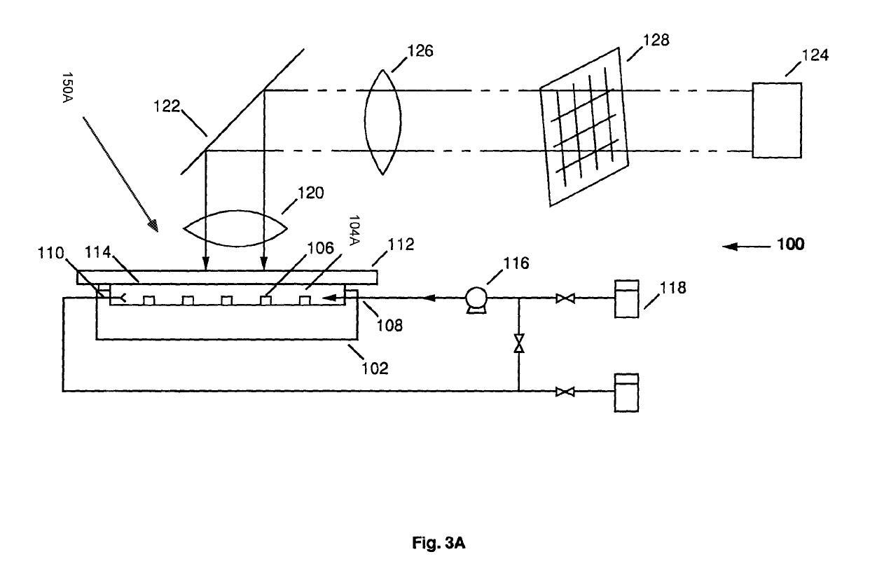

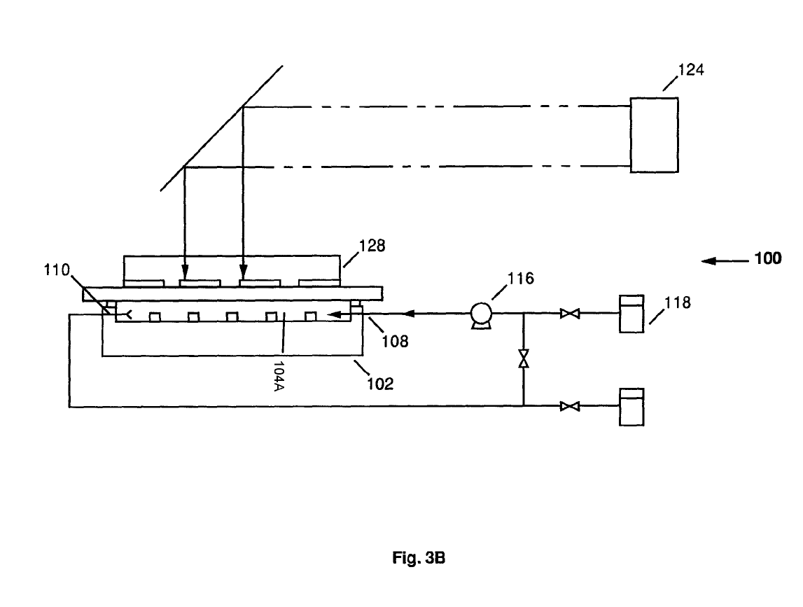

A schematic illustration of a device for carrying out the combined photolysis/chemistry steps of the individual process is shown in FIGS. 3A and 3B. These figures show a cross-sectional view of alternate embodiments of the flow cell system 100. Referring first to FIG. 3A, the device includes a flow cell 150A which is made up of a body 102 having a cavity or reaction chamber 104A disposed in one surface. The cavity generally includes fluid inlets 108 and outlets 110 for flowing fluid into and through the cavity. The cavity may optionally include ridges 106 on the back surface of the cavity to aid in mixing the fluids as they are pumped into and through the cavity. The substrate 112 is mounted over the cavity whereby the front surface of the substrate 114 (the surface upon which the arrays are to be synthesized) is in fluid communication with the cavity. The device also includes a fluid delivery system in fluid connection with the fluid inlet 108 for delivering selected fluids into the cavity to contact the first surface of the substrate. The fluid delivery system typically delivers selected fluids, e.g., monomer containing solutions, index matching fluids, wash solutions, etc., from one or more reagent reservoirs 118, into the cavity via the fluid inlet 108. The delivery system typically includes a pump 116 and one or more valves to select from the various reagent reservoirs.

For carrying out the photolysis reactions, the system 100 also typically includes a light source 124, as described above. The light source is shown through a photolithographic mask 128 and is directed at the substrate 112. Directing the light source at the substrate may generally be carried out using, e.g., mirrors 122 and/or lenses 120 and 126. Alternatively, as shown in FIG. 3B, the mask 128 may be placed directly over the substrate 112, i.e., immediately adjacent to the substrate, thereby obviating the need for intervening lenses.

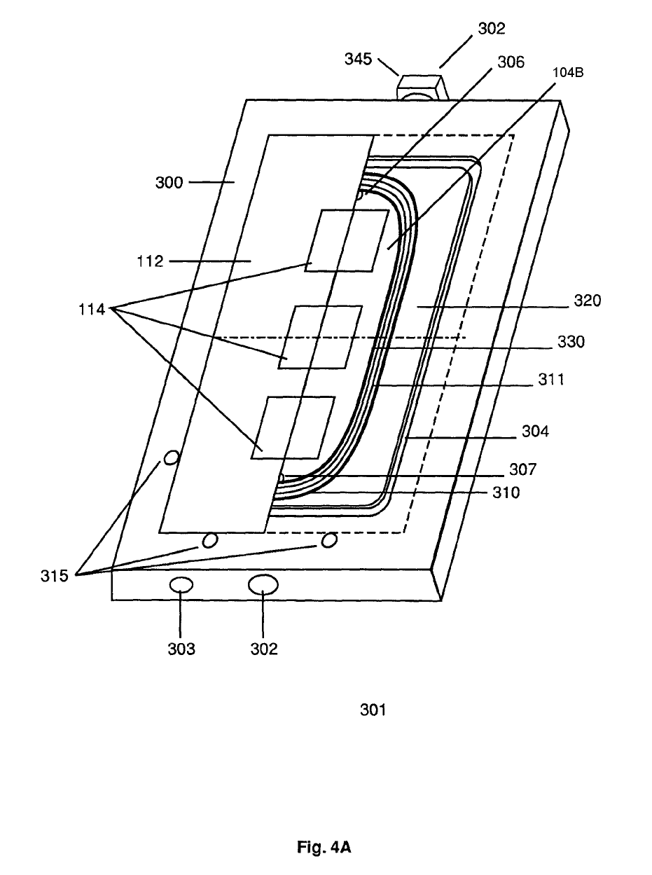

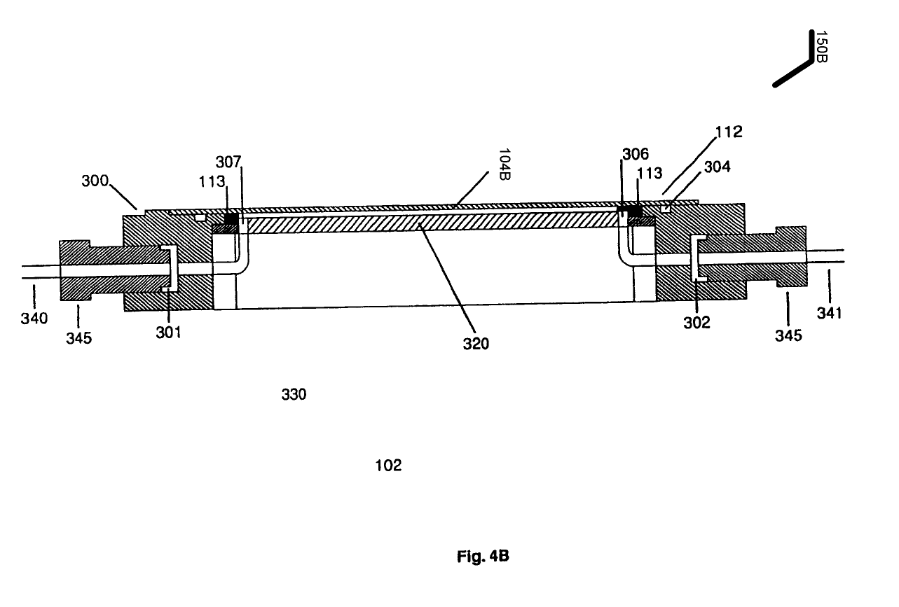

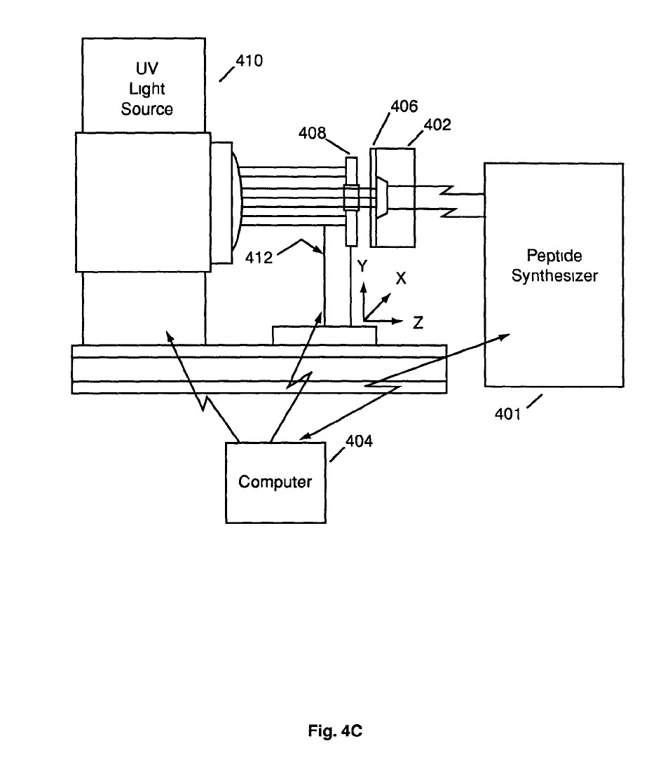

FIGS. 4A and 4B show different views of schematic illustrations of one embodiment of a flow cell 150B portion of the device, e.g., the body substrate combination. As shown in FIGS. 4A and 4B, a panel 320 is mounted to the body 102 to form the bottom surface of the cavity or reaction chamber 104B. Silicone cement or other adhesive may be used to mount the panel and seal the bottom of the cavity. In other aspects, panel 320 will be a light absorptive material, such as yellow glass, RG1000 nm long pass filter, or other material which absorbs light at the operating wavelengths, for eliminating or minimizing reflection of impinging light. As a result, the burden of filtering stray light at the incident wavelength during synthesis is significantly lessened. The glass panel also provides a durable surface for forming the cavity since it is relatively immune to corrosion in the high salt environments or other conditions common in DNA synthesis reactions or other chemical reactions.

The substrate 112 is mated to a surface 300. The first surface 114 of the substrate includes the photalabile protecting groups coupled to functional groups coupled to the substrate surface, as described above. In some embodiments, vacuum pressure may be used to mate the substrate to the surface 300. In such embodiments, a groove 304, which may be about 2 mm deep and 2 mm wide, is formed on surface 300. The groove communicates with an opening 303 that is connected to a vacuum source, e.g., a pump. The vacuum source creates a vacuum in the groove and causes the substrate to adhere to surface 300.

A groove 310 may be formed on surface 300 for seating a gasket 311 therein. The gasket ensures that the cavity is sealed when the substrate is mated to the flow cell 150B. Alignment pins 315 may be optionally provided on surface 300 to properly align the substrate on the flow cell.

Inlet port 307 and outlet port 306 are provided for introducing fluids into and flowing fluids out of the cavity. The flow cell provides an opening 301 in which a flow tube 340 is passed through for coupling to inlet port 307. Likewise, a flow tube 341 is passed through opening 302 for coupling with outlet port 306. Fittings 345 are employed to maintain the flow tubes in position. Openings 301 and 302 advantageously position the flow tubes so that the flow cell can easily and conveniently be mounted on the synthesis system.

A pump, which is connected to one of the flow tubes, circulates a selected fluid into the cavity and out through the outlet port for recirculation or disposal. The selected fluids may include, e.g., monomer containing solutions, index matching fluids, wash solutions or the like. Although described in terms of a pump, a variety of pressurized delivery systems may be used to deliver fluids to the cavity. Examples of these alternate systems utilize argon gas to circulate the selected fluid into and through the cavity. Simultaneously, the flow of argon gas may be regulated to create bubbles for agitating the fluid as it is circulated through the system. Agitation is used to mix the fluid contents in order to improve the uniformity and/or yield of the reactions.

As shown, inlet and outlet ports 306 and 307, respectively, are located at opposite ends of the panel. This configuration improves fluid circulation and regulation of bubble formation in the cavity. In one embodiment, the outlet and inlet are located at the top and bottom ends of the cavity, respectively, when the flow cell is mounted vertically on the synthesizer. Locating the outlet and inlet at the highest and lowest positions in the cavity, respectively, facilitates the removal of bubbles from the cavity.

In some embodiments, the flow cell may be configured with a temperature control system to permit the synthesis reactions to be conducted under optimal temperature conditions. Examples of temperature control systems include refrigerated or heated baths, refrigerated air circulating devices, resistance heaters, thermoelectric peltier devices and the like.

In some instances, it may be desirable to maintain the volume of the flow cell cavity as small as possible so as to more accurately control reaction parameters, such as temperature or concentration of chemicals. In addition to the benefits of improved control, smaller cavity volumes may reduce waste, as a smaller volume requires a smaller amount of material to carry out the reaction.

For particularly small cavity volumes, a difficulty may arise where bubbles in the reaction fluids can become trapped in the cavity, which may result in incomplete exposure of the substrate surface to the reaction fluid. In particular, when a fluid fills into a very shallow channel or slit, it will tend to fill the shallowest areas first, due to relatively strong capillary forces in those areas. If the channel is too shallow, inconsistency and non-flatness of the substrate which results in uneven capillary forces, will lead to an uneven fluid front during filling. As the liquid front loses its even shape, liquid may surround air or gas pockets to produce trapped bubbles. Accordingly, where particularly small cavity volumes are desired, a flow cell may be employed wherein the top and bottom surfaces of the flow cell are nonparallel, being narrower at the inlet of the flow cell, and growing wider toward the outlet. Uniform filling of the flow cell ensures that the fluid front maintains a straight shape, thereby minimizing the potential of having bubbles trapped between the surfaces.

A schematic illustration of one embodiment of an integrated flow cell system is shown in FIG. 4C. The device includes an automated peptide synthesizer 401. The automated peptide synthesizer is a device which passes selected reagents through a flow cell across a surface of a substrate under the direction of a computer 404. In another embodiment the synthesizer is an ABI Peptide Synthesizer, model no. 431A. The computer may be selected from a wide variety of computers or discrete logic including, for example, an IBM PC-AT or similar computer linked with appropriate internal control systems in the peptide synthesizer. The PC is provided with signals from the ABI computer indicative of, for example, the beginning of a photolysis cycle. One can also modify the synthesizer with a board that links the contacts of relays in the computer in parallel with the switches to the keyboard of the control panel of the synthesizer to eliminate some of the keystrokes that would otherwise be required to operate the synthesizer.

Substrate 406 is mounted on the flow cell, forming a cavity between the substrate and the flow cell. Selected reagents flow through this cavity from the peptide synthesizer at selected times, forming an array of peptides on the face of the substrate in the cavity. Mounted above the substrate, and may be in contact with the substrate is a mask 408. Mask 408 is transparent in selected regions to a selected wavelength of light and is opaque in other regions to the selected wavelength of light. The mask is illuminated with a light source 410 such as a UV light source. In one specific embodiment the light source 410 is a model No. 82420 made by Oriel. The mask is held and translated by an x-y translation stage 412. Translation stages may be obtained commercially from, e.g., Newport Corp. The computer coordinates the action of the peptide synthesizer, translation stage, and light source. Of course, the invention may be used in some embodiments with translation of the substrate instead of the mask.

### 2. Photolysis Step

As described above, photolithographic methods are used to activate selected regions on the surface of the substrate. Specifically, functional groups on the surface of the substrate or present on growing polymers on the surface of the substrate, are protected with photolabile protecting groups. Activation of selected regions of the substrate is carried out by exposing selected regions of the substrate surface to activation radiation, e.g., light within the effective wavelength range, as described previously. Selective exposure is typically carried out by shining a light source through a photolithographic mask. Alternate methods of exposing selected regions may also be used, e.g., fiberoptic faceplates, etc. For the individual process methods, e.g., the integrated photolysis/chemistry process, the substrate is mounted in the flow cell system or flow cell such that the synthesis surface of the substrate is facing the cavity and away from the light source. As the light source is shown on the surface opposite that upon which the photoprotective groups are provided, this method of exposure is termed “backside” photolysis.

Because the individual feature sizes on the surface of the substrate prepared according to the processes described herein can typically range as low as 1-10 μm on a side, the effects of reflected or refracted light at the surface of the substrate can have significant effects upon the ability to expose and activate features of this size. One method of reducing the occurrence of reflected light is to incorporate a light absorptive material as the back surface of the flow cell, as described above. Refraction of the light as it enters the flow cell, i.e., crosses the substrate/flow cell interface, through the back surface of the substrate can also result in a loss in feature resolution at the synthesis surface of the substrate resulting from refraction and reflection. To alleviate this problem, during the photolysis step, it is generally desirable to fill the flow cell with an index matching fluid (“IMF”) to match the refractive index of the substrate, thereby reducing refraction of the incident light and the associated losses in feature resolution. The index matching fluid will typically have a refractive index that is close to that of the substrate. Typically, the refractive index of the IMF will be within about 10% that of the substrate, and may be within about 5% of the refractive index of the substrate. Refraction of the light entering the flow cell, as it contacts the interface between the substrate and the IMF is thereby reduced. Where synthesis is being carried out on, e.g., a silica substrate. In one embodiment, an IMF is dioxane which has a refractive index roughly equivalent to the silica substrate.

The light source used for photolysis is selected to provide a wavelength of light that is photolytic to the particular protecting groups used, but which will not damage the forming polymer sequences. Typically, a light source which produces light in the UV range of the spectrum will be used. For example, in oligonucleotide synthesis, the light source typically provides light having a wavelength above 340 nm, to effect photolysis of the photolabile protecting groups without damaging the forming oligonucleotides. This light source is generally provided by a Hg-Arc lamp employing a 340 nm cut-off filter (i.e., passing light having a wavelength greater than 340-350 nm). Typical photolysis exposures are carried out at from about 6 to about 10 times the exposed half-life of the protecting group used. In one embodiment, the photolysis exposure is carried out at from 8-10 times the half-life. For example, MeNPOC has an exposed half-life of approximately 6 seconds, which translates to an exposure time of approximately 36 to 60 seconds.

Photolithographic masks used during the photolysis step typically include transparent regions and opaque regions, for exposing only selected portions of the substrate during a given photolysis step. Typically, the masks are fabricated from glass that has been coated with a light-reflective or absorptive material, e.g., a chrome layer. The light-reflective or absorptive layer is etched to provide the transparent regions of the mask. These transparent regions correspond to the regions to be exposed on the surface of the substrate when light is shown through the mask.

In general, it is desirable to produce arrays with smaller feature sizes, allowing the incorporation of larger amounts of information in a smaller substrate area, allowing interogation of larger samples, more definitive results from an interogation and greater possibility of miniaturization. Alternatively, by reducing feature size, one can obtain a larger number of arrays, each having a given number of features, from a single substrate. The result is substantially higher product yields for a given process. This technique, generally referred to as “die shrinking” is commonly used in the semiconductor industry to enhance product outputs or to reduce chip sizes following a over-sized test run of a manufacturing process. Methods to reduce feature size and further details of the synthesis steps are described in U.S. Pat. Nos. 7,332,373 and 6,307,042, which are hereby incorporated herein by reference in its entirety for all purposes.

### 3. Chemistry Step

Following each photolysis step, a monomer building block is introduced or contacted with the synthesis surface of the substrate. Typically, the added monomer includes a single active functional group, for example, in the case of oligonucleotide synthesis, a 3′-hydroxyl group. The remaining functional group that is involved in linking the monomer within the polymer sequence, e.g., the 5′-hydroxyl group of a nucleotide, is generally photoprotected. The monomers then bind to the reactive moieties on the surface of the substrate, activated during the preceding photolysis step, or at the termini of linker molecules or polymers being synthesized on the substrate.

Typically, the chemistry step involves solid phase polymer synthesis methods that are well known in the art. For example, detailed descriptions of the procedures for solid phase synthesis of oligonucleotides by phosphoramidite, phosphite-triester, phosphotriester, and H-phosphonate chemistries are widely available. See, for example, Itakura, U.S. Pat. No. 4,401,796; Caruthers et al., U.S. Pat. Nos. 4,458,066 and 4,500,707; Beaucage et al., Tetrahedron Lett., 22:1859-1862 (1981); Matteucci et al., J. Amer. Chem. Soc., 103:3185-3191 (1981); Caruthers et al., Genetic Engineering, 4:1-17 (1982); Jones, chapter 2, Atkinson et al., chapter 3, and Sproat et al., chapter 4, in Gait, ed. Oligonucleotide Synthesis: A Practical Approach, IRL Press, Washington D.C. (1984); Froehler et al., Tetrahedron Lett., 27:469-472 (1986); Froehler et al., Nucleic Acids Res., 14:5399-5407 (1986); Sinha et al. Tetrahedron Lett., 24:5843-5846 (1983); and Sinha et al., Nucl. Acids Res., 12:4539-4557 (1984).

In operation, during the chemistry/monomer addition step, the IMF is removed from the flow cell through an outlet port. The flow cell is then rinsed, e.g., with water and/or acetonitrile. Following rinsing, a solution containing an appropriately protected monomer to be coupled in the particular synthesis step is added. For example, where the synthesis is of oligonucleotide probe arrays, being synthesized in the 3′ to 5′ direction, a solution containing a 3′-O-activated phosphoramidite nucleoside, photoprotected at the 5′ hydroxyl is introduced into the flow cell for coupling to the photoactivated regions of the substrate. Typically, the phosphoramidite nucleoside is present in the monomer solution at a concentration of from 1 mM to about 100 mM. In one embodiment the phosphoramidite nucleoside is present in the monomer solution at a concentration of 10 mM. Typically, the coupling reaction takes from 30 seconds to 5 minutes. In one embodiment, the coupling reaction takes about 1.5 minutes.

Following coupling, the monomer solution is removed from the flow cell, the substrate is again rinsed, and the IMF is reintroduced into the flow cell for another photolysis step. The photolysis and chemistry steps are repeated until the substrate has the desired arrays of polymers synthesized on its surface.

For each photolysis/chemistry cycle, it will generally be desirable to maximize coupling efficiencies in order to maximize probe densities on the arrays. Coupling efficiencies may be improved through a number of methods. For example, coupling efficiency may be increased by increasing the lipophilicity of the building blocks used in synthesis. Without being bound to any theory of operation, it is believed that such lipophilic building blocks have enhanced interaction at the surface of the crystalline substrates. The lipophilicity of the building blocks may generally be enhanced using a number of strategies. In oligonucleotide synthesis, for example, the lipophilicity of the nucleic acid monomers may be increased in a number of ways. For example, one can increase the lipophilicity of the nucleoside itself, the phosphoramidite group, or the protecting group used in synthesis.

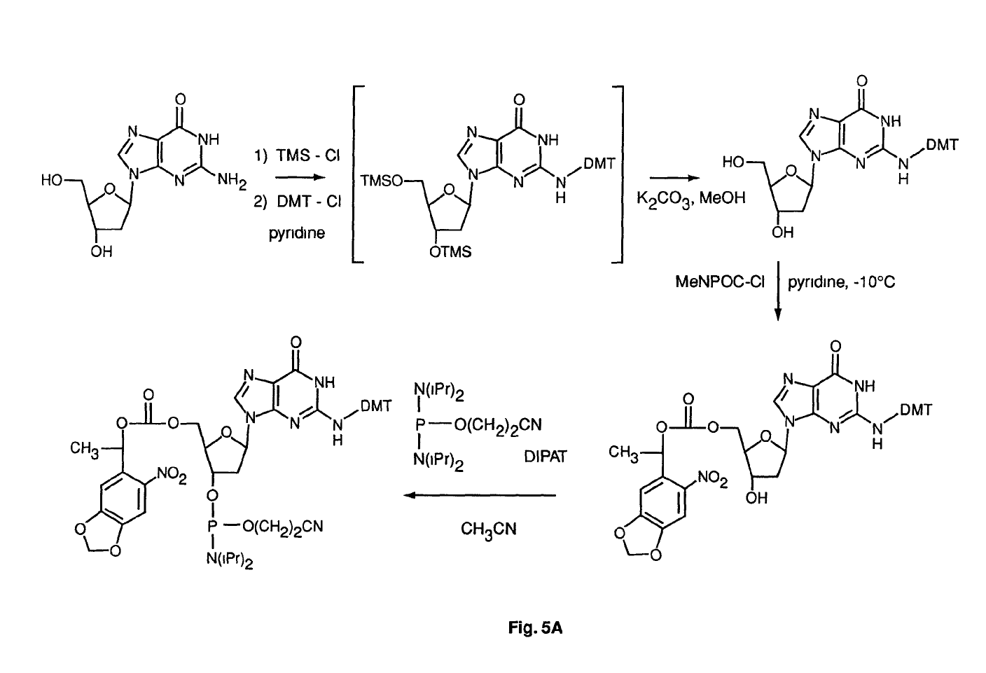

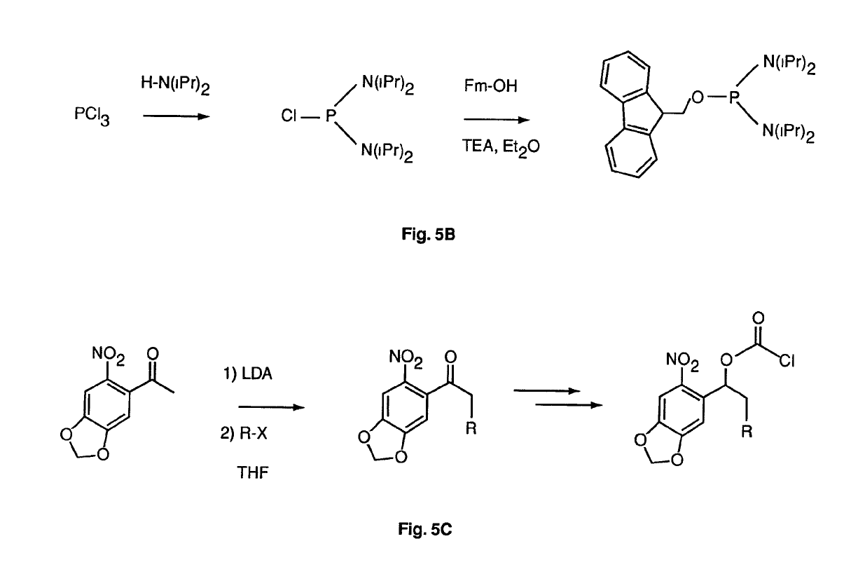

Modification of the nucleoside to increase its lipophilicity generally involves specific modification of the nucleobases. For example, deoxyguanosine (dG) may be alkylated on the exocyclic amino group (N2) with DMT-C1, after in situ protection of both hydroxyl groups as trimethylsilylethers (See, FIG. 5A). Liberation of the free DMT protected nucleoside is achieved by base catalyzed methanolosis of the di-TMS ether. Following standard procedures, two further steps are used resulting in the formation of 5′-MeNPOC-dG-phosphoramidites. The DMT group is used because the normally used 5′-DMT-phosphoramidites show high coupling efficiencies on silica substrate surfaces and because of the ease of synthesis for the overall compound. The use of acid labile protecting groups on the exocyclic amino groups of dG allows continued protection of the group throughout light-directed synthesis. Similar protection can be used for other nucleosides, e.g., deoxycytosine (dC). Protection strategies for nucleobase functional groups, including the exocyclic groups are discussed in U.S. patent application Ser. No. 08/445,332 (abandoned) filed May 19, 1995, previously incorporated herein by reference.

A more lipophilic phosphoramidite group may also be used to enhance synthesis efficiencies. Typical phosphoramidite synthesis utilizes a cyanoethyl-phosphoramidite. However, lipophilicity may be increased through the use of, e.g., an Fmoc-phosphoramidite group. Synthesis of Fmoc-phosphoramidites is shown in FIG. 5B. Typically, a phosphorus-trichloride is reacted with four equivalents of diisopropylamine, which leads to the formation of the corresponding monochloro-bisamino derivative. This compound reacts with the Fmoc-alcohol to generate the appropriate phosphatidylating agent.

As with the phosphoramidite group, the photolabile protecting groups may also be made more lipophilic. For example, a lipophilic substituent, e.g., benzyl, naphthyl, and the like, may be introduced as an alkylhalide, through α-akylation of a nitroketone, as shown in FIG. 5C. Following well known synthesis techniques, one generates the chloroformate needed to introduce the photoactive lipophilic group to the 5′ position of a deoxyribonucleoside.

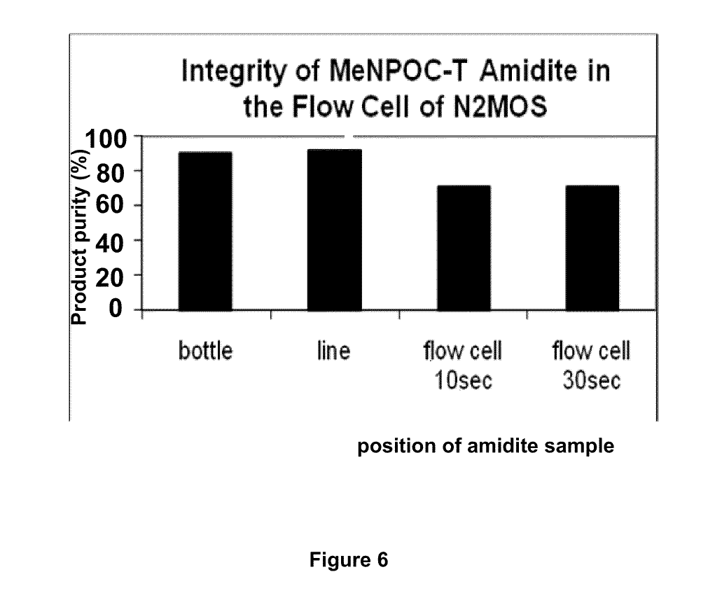

According to another embodiment, a monomer solution used to typically activate one surface of a substrate may be used to activate another substrate in the same or a different flow cell. The number of times the reagent in solution can be re-used will depend on several factors, for example, the number of substrates, the surface area of the substrates, and the transfer time from one reaction to chamber to another, and so forth. Usually, the reagent in solution is maintained at a high concentration to drive the reaction to completion. The amount of active MeNPOC-T amidite was measured in the amidite bottle, in the line before entering the flow cell, in the flow cell after 10 seconds of mixing, and in the flow cell after 30 seconds of mixing. FIG. 6 indicates that the decay from 10 seconds to 30 seconds is negligible. The amidite solution can be used to process two substrates at the same time. The reagent in solution can be placed in a reaction chamber with one substrate and then be transferred to another reaction chamber to couple the same monomer on another substrate. Alternatively, the reagent in solution can be placed in a reaction chamber with two substrates and then be transferred to another reaction chamber to couple the same monomer on to two other substrates.

In another embodiment of the invention, the reagent in solution used for the “spotting” methods and reaction chambers in microfludic devices can be reused. Descriptions of spotting methods can be found in PCT/US99/00730. Descriptions of microfludic devices can be found in U.S. Pat. Nos. 5,856,174, 5,922,591, 6,168,948 and 6,830,936, which are hereby incorporated herein by reference in its entirety for all purposes. The reagent in solution can be recycled or reused in a number of reaction chambers holding a nucleic acid array within a microfluidic device.

### B. Batch Processing

In a second embodiment of the substrate preparation process, each of the photolysis and chemistry steps involved in the synthesis operation are provided as separate unit operations. This method provides advantages of efficiency and higher feature resolution over the single unit operation process. In particular, the separation of the photolysis and chemistry steps allows photolysis to be carried out outside of the confines of the flow cell. This permits application of the light directly to the synthesis surface, i.e., without first passing through the substrate. This “front-side” exposure allows for greater definition at the edges of the exposed regions (also termed “features”) by eliminating the refractive influence of the substrate and allowing placement of the mask closer to the synthesis surface.

In addition to the benefits of front side exposure, the batch method provides advantages in the surface area of a substrate that may be used in synthesizing arrays. In particular, by combining photolysis/chemistry aspects in the individual process methods, the operation of mounting the substrate on the flow cell may result in less than the entire surface of the substrate being used for synthesis. In particular, where a substrate is used to form one wall of the flow cell, as is typically the case in these combined methods, engineering constraints involved in mounting of the flow cell can result in a reduction in the available substrate surface area. This is particularly the case where a vacuum chuck system is used to mount the substrate on the flow cell, where the vacuum chuck system requires a certain amount of surface area to hold the substrate on the flow cell with sufficient force.

In batch mode operation, the chemistry step is generally carried out by immersing the entire wafer in the monomer solution, thus allowing synthesis over most if not all of the wafer's synthesis surface. This results in a higher chip yield per wafer than in the individual processing methods. Additionally, as the chemistry steps are generally the time limiting steps in the synthesis process, monomer addition by immersion permits monomer addition to multiple substrates at a given time, while more substrates are undergoing the photolysis steps.

For example, where synthesis is performed in the individual processing operation, as described above, the engineering constraints in vacuum mounting a substrate to a flow cell can result in a significant decrease in the size of a synthesis area on the substrate. For example, in one process, a wafer having dimensions of 5″×5″ has only 2.5″×2.5″ available as a synthesis surface, which when separated into chips of typical dimensions (e.g., 1.28 cm×1.28 cm) typically results in 16 potential chips per wafer. The same sized wafer, when subjected to the batch mode synthesis can have a synthesis area of about 4.3″×4.3″, which can produce approximately 49 chips per wafer.

In general, a number of wafers is subjected to the photolysis step. Following photolysis, the number of wafers is placed in a rack or “boat” for transport to the station which performs the chemistry steps, whereupon one or more chemistry steps are performed on the wafers, simultaneously. The wafers are then returned to the boat and transported back to the station for further photolysis. Typically, the boat is a rack that is capable of carrying several wafers at a time and is also compatible with automated systems, e.g., robotics, so that the wafers may be loaded into the boat, transported and placed into the chemistry station, and following monomer addition returned to the boat and the photolysis station, all through the use of automated systems. In an alternate embodiment, a plurality of wafers can be synthesized by rotating the wafers throughout a number of photolysis and chemistry equipment. For example, three or four wafers can be process with 1 photolysis equipment and 2 reaction chambers or other combinations which will be apparent to anyone skilled in the art.

Initial substrate preparation is the same for batch processing as described in the individual processing methods, above. However, beyond this initial substrate preparation, the two processes take divergent paths. In batch mode processing, the photolysis and chemistry steps are performed separately. As is described in greater detail below, the photolysis step is generally performed outside of the flow cell. This can cause some difficulties, as there is no provision of an IMF behind the substrate to prevent the potentially deleterious effects of refraction and reflection of the photolytic light source. In some embodiments, however, the same goal is accomplished by applying a coating layer to the back-side of the substrate, i.e., to the non-synthesis surface of the substrate or the front-side of the coating. The coating layer may be applied after or before the substrate preparation process, but prior to derivatization. This coating is typically selected to perform one or more of the following functions: (1) match the refractive index of the substrate to prevent refraction of light passing through the substrate which may interfere with the photolysis; and (2) absorb light at the wavelength of light used during photolysis, to prevent back reflection which may also interfere with photolysis.

As described previously, the steps of photolysis and monomer addition in the batch mode aspects of the invention are performed in separate unit operations. Separation of photolysis and chemistry steps allows a more simplified design for a photolyzing apparatus. Specifically, the apparatus need not employ a flow cell. Additionally, the apparatus does not need to employ a particular orientation to allow better filling of the flow cell. Accordingly, the apparatus will typically incorporate one or more mounting frames to immobilize the substrate and mask during photolysis, as well as a light source. The device may also include focusing optics, mirrors and the like for directing the light source through the mask and at the synthesis surface of the substrate. As described above, the substrate is also placed in the device such that the light from the light source impacts the synthesis surface of the substrate before passing through the substrate. As noted above, this is termed “front-side” exposure.

In one embodiment, a photolysis step requires far less time than a chemistry step, e.g., 60 seconds as compared to 10 minutes. Thus, in the individual processing mode where the photolysis and chemistry steps are combined, the photolysis machinery sits idle for long periods of time during the chemistry step. Batch mode operation, on the other hand, allows numerous substrates to be photolyzed while others are undergoing a particular chemistry step. For example, a number of substrates may be exposed for a given photolysis step. Following photolysis, the several wafers may be transferred to a number of reaction chambers for the monomer addition step. While monomer addition is being carried out, additional wafers may be undergoing photolysis.

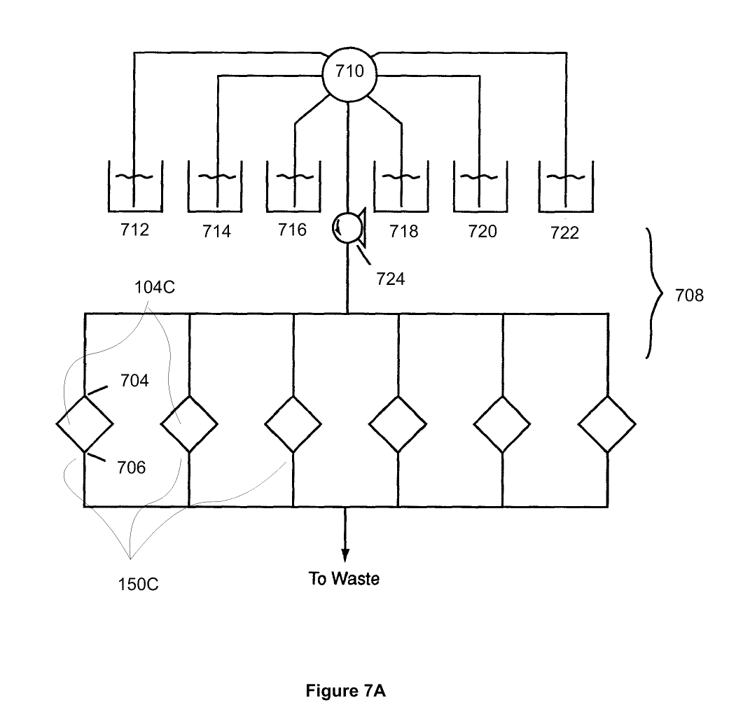

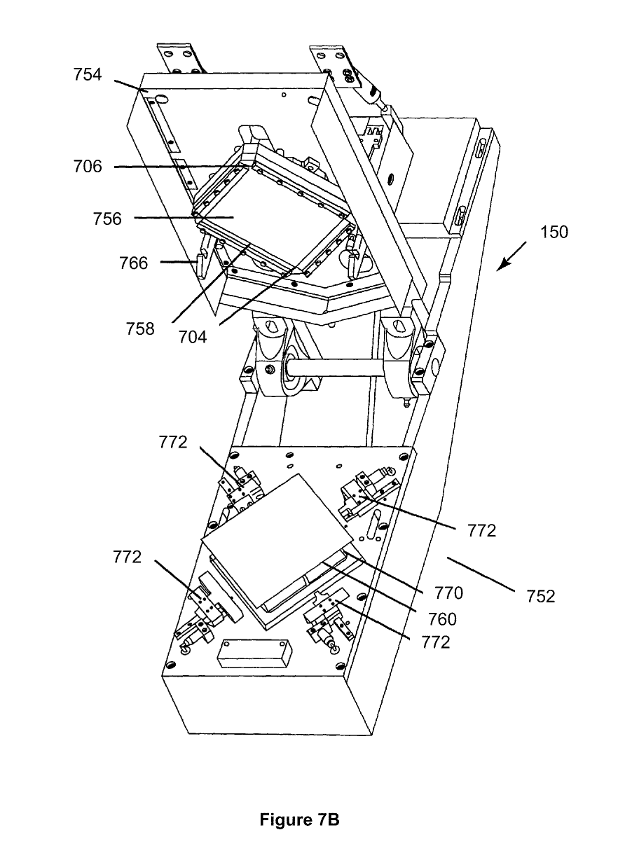

FIG. 7A schematically illustrates a flow cell system with multiple, for example, six, flow cells 150C. These banks of reaction chambers 104C can be used to carry out, for example, simultaneous monomer addition steps on a number of separate substrates in parallel. As shown, the bank of reaction chambers can be configured to simultaneously perform identical synthesis steps in each of the several reaction chambers. Each reaction chamber 104C is equipped with a fluid inlet 704 and outlet 706 for flowing various fluids into and through the reaction chamber. The fluid inlet of each chamber is generally fluidly connected to a manifold 708 which connects all of the reaction chambers, in parallel, to a single valve assembly 710. In one embodiment, rotator valves are provided. The valve assembly allows the manifold to be fluidly connected to one of a plurality of reagent vessels 712-722. Also included is a pump 724 for delivering the various reagents to the reaction chamber. Although primarily described as performing the same synthesis steps in parallel, the bank of reaction chambers could also be readily modified to carry out to perform multiple independent chemistry steps. In an embodiment, all or at least one of the reaction chambers can provide a different chemical reaction step. In a further embodiment, a number of separate flow cells can used in combination with at least one photolysis equipment to synthesize a wafer. A computer can be programmed to deliver different reagents to specific reaction chambers depending on what is required. The outlet ports 706 from the reaction chambers 104C are typically fluidly connected to a waste vessel (not shown).

FIG. 7B shows a schematic representation of a flow cell with a single reaction chamber for performing the chemistry steps of the batch process, e.g., monomer addition. As shown, the flow cell 150D employs a “clam-shell” design wherein the substrate is enclosed in the reaction chamber 104D when the door 752 is closed against the body 754 of the apparatus. More particularly, the substrate, for example, a wafer 760 is mounted on the chamber door and held in place, e.g., by a vacuum chuck shown as vacuum groove 770. The wafer can be placed into position on the door manually, or automatically by a mechanical mechanism, for example a robotic arm. The wafer can be aligned by using automatic alignment pins 772, e.g., solenoid or servo operated, for aligning a wafer on the vacuum groove 770. When the door 752 is closed, the wafer 760 is placed into the flow cell cavity 756 on the body of the device. The flow cell cavity is surrounded by a gasket 758, which provides the seal for the reaction chamber when the door is closed. Upon closing the door, the wafer is pressed against the gasket and the pressure of this contact seals the reaction chamber 104D. The reaction chamber includes a fluid inlet 704 and a fluid outlet 706, for flowing monomer solutions into and out of the reaction chamber.

The apparatus may also include latches 766, for locking the reaction chamber in a sealed state. Once sealed, reagents are delivered into the reaction chamber through fluid inlet 762 and out of the reaction chamber through fluid outlet 764. The reaction chamber also typically includes a temperature control element for maintaining the reaction chamber at the optimal synthesis temperature.

Following a monomer addition step, the wafers are each subjected to a further photolysis step. The process may generally be timed whereby during a particular chemistry step, a new series of wafers is being subjected to a photolysis step. This dramatically increases the throughput of the process.

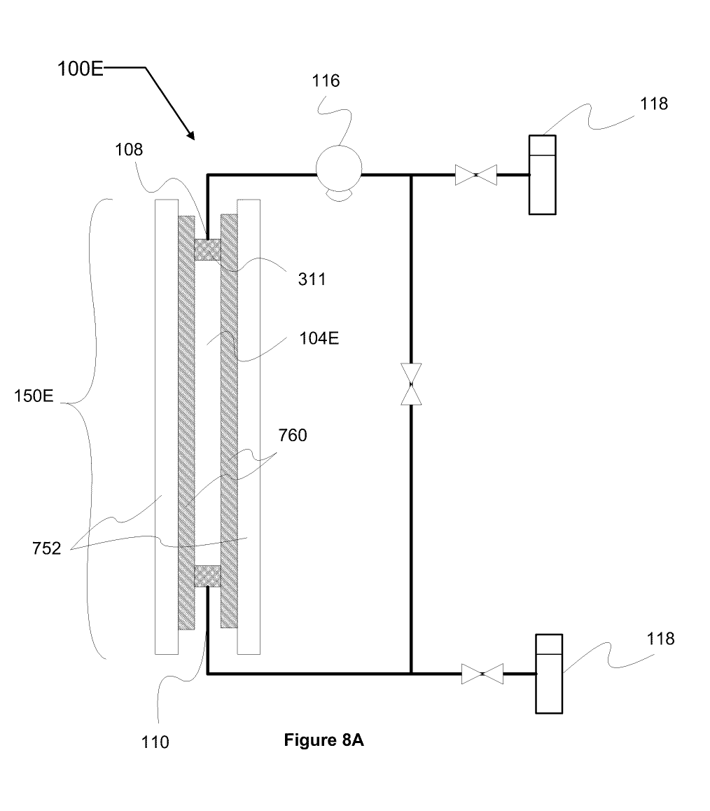

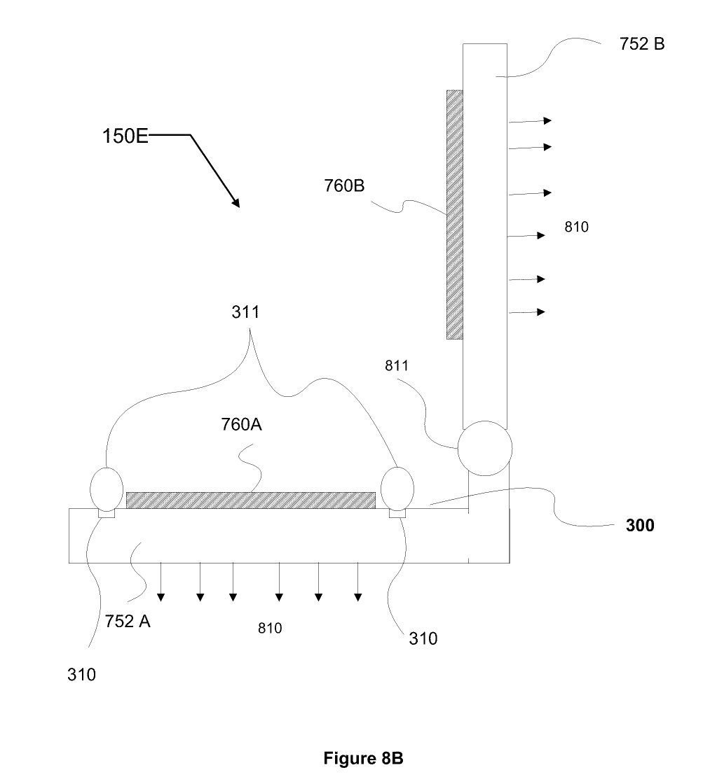

As described previously, the photolysis step requires far less time than a typical chemistry step. According to one embodiment, the substrate preparation process may combine a plurality of substrates during the chemistry step in one reaction chamber. The reaction chamber is capable of holding more than one substrate, for example, two wafers. In one embodiment, the same volume of reagent solution, for example, an amidite solution, required to process a single wafer as described above, can be used to process two wafers using this reaction chamber which can process two wafers at the same time. One advantage of utilizing the dual substrate reaction chambers is to reduce manufacturing costs by reducing the usage of reagent solution in synthesizing the wafers. According to one embodiment, the reaction chamber would be designed such that the two wafers would be facing each other in the reaction chamber. Examples of a reaction chamber that can process two substrates at the same time are shown in FIGS. 8-10.

FIG. 8A shows a schematic representation of an example of a flow cell system 100E for performing the chemistry steps of a batch process, e.g., monomer addition, for two wafers. This figure shows a cross-sectional view of alternate embodiments of the flow cell system 100E. The device includes a flow cell 150E which is made up of a body, for example, doors 752, and a cavity or reaction chamber 104E between two substrates 760. The cavity generally includes fluid inlets 108 and outlets 110 for flowing fluid into and through the cavity. The wafers are mounted, on the doors 752, whereby the front surface of the wafers (the surface upon which the arrays are to be synthesized) is in fluid communication with the cavity. The device also includes a fluid delivery system in fluid connection with the fluid inlet 108 for delivering selected fluids into the cavity to contact the first surface of the substrate. The fluid delivery system typically delivers selected fluids, e.g., monomer containing solutions, index matching fluids, wash solutions, etc., from one or more reagent reservoirs 118, into the cavity via the fluid inlet 108. The delivery system typically includes a pump 116 and one or more valves to select from the various reagent reservoirs.

This system is similar to the one illustrated in FIGS. 3A and 3B, however, The reaction chamber gap is controlled by the spacing between the two substrates instead of the spacing between a single substrate and the wall of the reaction chamber. As shown in FIG. 8B, the flow cell 150E employs a “clam-shell” design wherein two substrates are enclosed in the reaction chamber 104E when the doors 752A and 752B are closed. More particularly, the first substrate 760A is mounted on the first chamber door 752A and held in place, e.g., by a vacuum chuck, shown as vacuum 810. The second substrate 760B is mounted on the second chamber door 752B. The second door then closes to form a reaction chamber where the first substrate faces the second substrate. The gasket 311 ensures that the cavity is sealed when both substrates are mated creating the reaction chamber. A groove 310 may be formed on surface 300 for seating a gasket 311 therein. The rotating pin 811 allows for adjustments in aligning the two substrates on top of each other. Alignment pins 772 may be optionally provided on the surface 300 to properly align the substrate on the flow cell. The apparatus may also include latches 766, for locking the reaction chamber in a sealed state. Once sealed, reagents are delivered into the reaction chamber through fluid inlet and out of the reaction chamber through a fluid outlet. The reaction chamber also typically includes a temperature control element for maintaining the reaction chamber at the optimal synthesis temperature.

According to one aspect, the substrates are loaded onto the doors. The doors are then closed so that the two substrates form a cavity. The chemical monomers are introduced into the reaction chamber through the fluid inlet into the cavity and contacted with the synthesis surface, where the monomers can bind with the active functional groups on the substrate surface. The monomer containing solution is then removed from the reaction chamber through the fluid outlet.

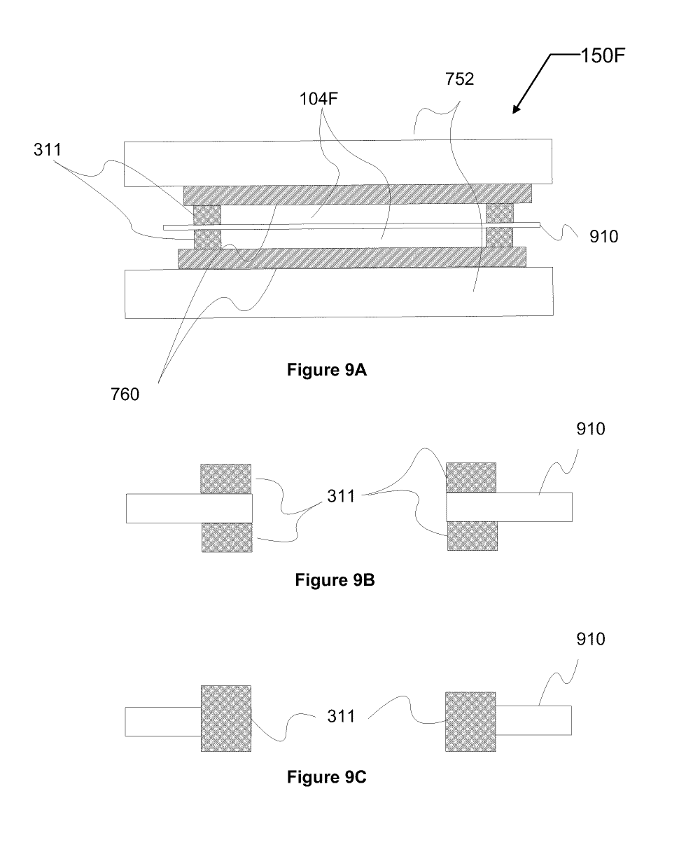

According to an embodiment of the invention, the depth of the chamber created by the surfaces of the two substrates is minimized such that the volume of reagents used is similar to the volume used to process one substrate. Examples of using a gasket to create the reaction chamber are shown in FIGS. 9A, 9B and 9C. A frame 910 is used to stabilize the gasket 311. The shape of the frame may be the same shape as the substrates, with the center being open. FIG. 9A illustrates a closed flowcell 150F with a reaction chamber 104F that includes 2 substrates 760. The gasket may be placed on both sides of the frame, as shown in FIG. 9B or the gasket can be an extension of the inside border of a frame as shown in FIG. 9C.

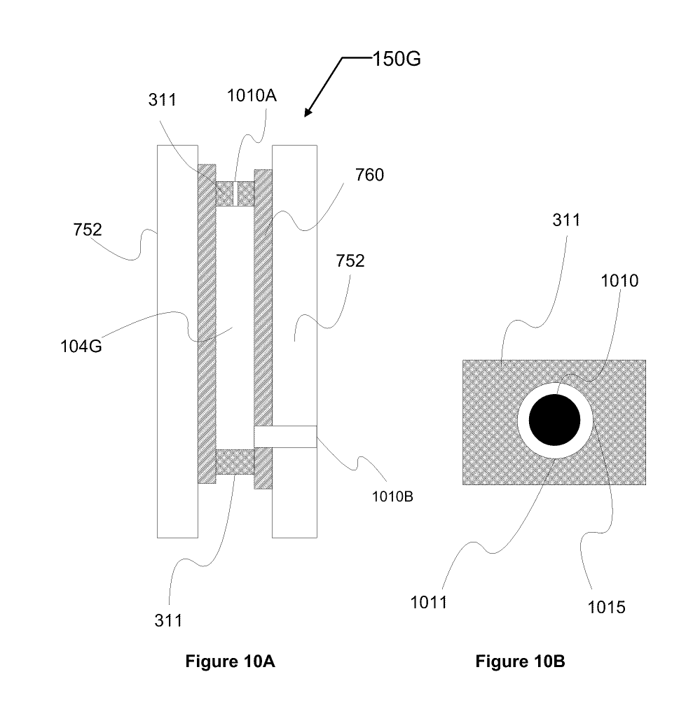

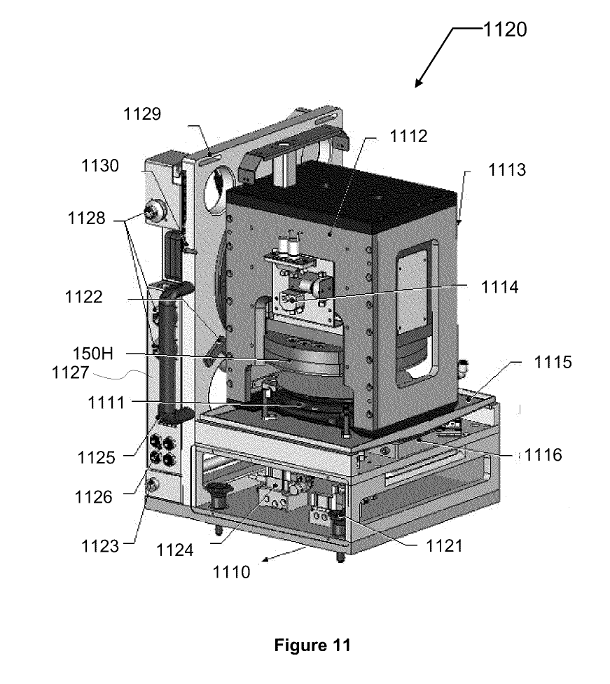

The reaction chamber 104G includes a fluid inlet and a fluid outlet, for flowing monomer solutions into and out of the reaction chamber. Examples of fluid inlet locations 1010A and outlet locations 1010B of the flow cell 150G are shown in FIGS. 10A and 10B according to an embodiment of the invention. Reagents can be introduced and/or removed from the reaction chamber via a hole, for example, in the gasket 311, through the substrate 760, and or through the chamber door 752, and the like. The two substrate reaction chamber can be set up vertically where the hole can be available at the top of the assembly 1010A such that the reaction chamber can be filled. The reaction chamber can then be rotated 180 degrees such that the hole is located at the bottom to empty the reagent from the reaction chamber according to an embodiment of the invention. Furthermore, the method can include a piercing step, where a material, for example, rubber, is pierced with a needle to introduce the reagent through a hole. The material would be compatible with the reagents and pliable such that a needle can pierce it and be removed without creating a non-sealable leak.

In one embodiment, a plug or septum may be used to close off the chamber. The septum may be made out of a rubber, teflon/rubber laminate, or other sealing material. The septum may be of the type commonly used to seal and reseal vessels when a needle is inserted into the septum for addition/removal of fluids. In a further embodiment, a ring shape structure 1015 composed of a harder material can provide structure to a plug. In another embodiment, the ring shape structure could be part of a tube in a reaction chamber with a depth of, for example, 0.030″. The overall material is pliable allowing the entire plug assembly to deform while the 2 substrates are pressed together to create a seal. Once the chemical reaction is complete, the pressure is turned off, the plug assembly is relaxed and the reagent can then be removed.

According to another embodiment, the substrates can be loaded onto the doors by first arranging the first wafer onto the first door with a gasket capable of being pre-filled with a reagent. The gasket is filled with a reagent, where the active side of the first substrate is covered with the reagent. The second substrate is loaded onto the second door and also placed under vacuum. The second door closes on top of the first door, creating a reaction chamber between the two substrates. Other methods which are known to one skilled in the art can also be used to introduce and remove reagents from the reaction chamber.

There can be several advantages in processing a plurality of substrates in a single reaction chamber, for example, a significant reduction in reagent use per substrate, a significant reduction in the overall synthesis time per substrate per MOS unit, and reduction in the footprint of the synthesis equipment per substrate.

The shape of a reaction chamber typically depends on the shape of the substrate.

Usually, the shape of the reaction chamber is similar to the shape of the substrate. For example, as shown in FIG. 7B, a square shaped substrate is placed in a square shaped reaction chamber 104D. The shape can be, for example, square, rectangular (for example, a slide), circular, oval, and so forth. An example of a circular flow cell is shown in FIG. 11, where the reaction chamber 104H is circular. The reaction chamber which can be modified to construct chambers for various size, shape, type of substrates in various solutions for various processes are understood by one skilled in the art in various applications, for example, biological, biotechnology, chemical reactions, and the like.

According to another embodiment, similar designs could be made to hold more than two substrates in a reaction chamber cavity. In one embodiment, a four substrate flow cell system can be made by placing two substrates arranged top-to-bottom and face-to-face with two additional substrates in the same configuration.

According to a further embodiment of the invention, a flow cell can rotate any number between 0 to 90 degrees to be able to mix the reagents inside the flow cell. In another embodiment, the flow cell can rotate between +90 and −90 degrees. FIG. 11 shows a flow cell that can rotate from its home position to +90 degrees. A monomer addition can be performed by the following methods:
1) Rotate the flow cell to +90 degrees, then deliver reagents into the flow cell while the flow cell is upright and mix by pulsing the reagents.
2) Rotate the flow cell to +90 degrees, then deliver reagents into the flow cell while the flow cell is upright. Mix the reagents in the flow cell by rocking the flow cell back and forth from the 0 position to the +90 position.
3) Rotate the flow cell to +90 degrees, then deliver reagents into the flow cell while the flow cell is upright. Mix by a combination of pulsing and rotating the flow cell back and forth.

There are several other methods that are modifications of the methods described above that would be understood by someone skilled in the art. FIG. 11 shows the front 1110 view of the rotating circular flow cell 150H. The rotating flow cell is a modular design that can be described in the following categories: (1) fluidic parts, (2) mechanical parts for rotation, (3) parts for the modular design and (4) other general parts.

The fluidic parts include incoming and outgoing lines which are connected to the fluid connection port 112. These fluidic lines loop through block 1127 and through the center of the flow cell, where the lines are connected to the flow cell chemical blocks 1113 and 1114. Depending on the rotary position of the flow cell, either block 1113 or 1114 can be used as an inlet or as an outlet. The incoming and outgoing lines of port 1123 can be connected to a separate delivery system with fluidic delivery and waste connections.

The mechanical parts for the rotation can include a robotic arm that transfers substrates off and onto a vacuum chuck 1111. Alternatively, a substrate can be placed onto the vacuum chuck manually. A vacuum chuck 1111 is connected to two air cylinders 1112 allowing the flow cell to be lifted up to the glass plate and the substrate to be clamped into position. A rotary mechanism can now rotate the flow cell to any position from home to +90 degree or from home to −90 degree, with home being 0 degrees. Two rotary stops 1122 may prevent the clamp from opening when not at 0 degrees. The reagents are then dispensed into the flow cell across the surface of the substrate. After the chemistry step, the flow cell is opened and the substrate is removed. Regulator valves 1124 are used to adjust the force of the clamping mechanism. A lock pin 1130 is provided to lock the flow cell in place for maintenance purposes and other safety reasons.

The modular design includes connections to and from the modular flow cell, which are designed to be easily connected and disconnect. These connections include the fluidic connections 1123, the facility connections 1126 (i.e. CDA, vacuum, Argon and exhaust) and the electrical connections 1128 through a top, center and bottom connector. The modular flow cell can be mounted in the correct location by the locator pins 1121 and can be removed by attaching a lifting mechanism to the lift brackets 1129.

The other general parts include of a leak tray 1115 to capture any spilled reagent, two leak sensor blocks 1116 that are located underneath, a leak sensor that is located underneath the drain in the leak tray, and a vacuum gauge 1125 used to indicate whether a substrate is attached to the vacuum chuck 1111.

Following overall synthesis of the desired polymers on the substrate, permanent protecting groups, e.g., those which were not removed during each synthesis step, typically remain on nucleobases and the phosphate backbone of synthetic oligonucleotides. Removal of these protecting groups is usually accomplished with a concentrated solution of aqueous ammonium hydroxide. While this method is effective for the removal of the protecting groups, these conditions can also cleave the synthetic oligomers from the support (usually porous silica particles) by hydrolyzing an ester linkage between the oligo and a functionalized silane derivative that is bonded to the support. In VLSIPS oligonucieotide arrays, it is desirable to preserve the linkage connecting the oligonucleotides to the glass after the final deprotection step. For this reason, synthesis is carried out directly on glass which is derivatized with a hydroxyalkyl-trialkoxysilane (e.g., bis(hydroxyethyl)aminopropylsilane). However, these supports are not completely stable to the alkaline hydrolysis conditions used for deprotection. Depending upon the duration, substrates left in aqueous ammonia for protracted periods can suffer a loss of probes due to hydroxide ion attack on the silane bonded phase.

Accordingly, in other embodiments, final deprotection of the polymer sequences is carried out using anhydrous organic amines. In particular, primary and secondary alkylamines are used to effect final deprotection. The alkylamines may be used undiluted or in a solution of an organic solvent, e.g. ethanol, acetonitrile, or the like. Typically, the solution of alkyl amine will be at least about 50% alkylamine (v/v). A variety of primary and secondary amines are suitable for use in deprotection, including ammonia, simple low molecular weight (C₁₋₄) alkylamines, and substituted alkylamines, such as ethanolamine and ethylenediamine. In another embodiment, more volatile amines are provided where removal of the deprotection agent is to be carried out by evaporation, whereas the less volatile amines are provided in instances where it is desirable to maintain containment of the deprotection agent and where the solutions are to be used in repeated deprotections. Solutions of ethanolamine or ethylenediamine in ethanol have been used in deprotecting synthetic oligonucleotides in solution. See, Barnett, et al., Tet. Lett. (1981) 22:991-994, Polushin, et al., (1991) N.A.R. Symp. Serial No. 24:49-50 and Hogrefe, et al. N.A.R. (1993) 21:2031-2038.

Depending upon the protecting groups to be removed, the time required for complete deprotection in these solutions ranges from several minutes for “fast” base-protecting groups, e.g. PAC or DMF-protected A, C or G and Ibu-protected C, to several hours for the standard protecting groups, e.g. benzoyl-protected A, C or G and Ibu-protected G. By comparison, even the fast protecting groups require 4-8 hours for complete removal in aqueous ammonia. During this time, a significant percentage (e.g., 20-80%) of probes are cleaved from a glass substrate through hydrolytic cleavage of the silane layer, whereas after 48 hours of exposure to 50% ethanolic ethylenediamine solution, 95% of the probes remain on the substrate.

### V. Assembly of Probe Array

Following synthesis, final deprotection and other finishing steps, for example, a polymer coat removal where necessary, the substrate is assembled for use as individual substrate segments. Assembly typically employs the steps of separating the substrate into individual substrate segments, and inserting or attaching these individual segments to a housing which includes a reaction chamber in fluid communication with the front surface of the substrate segment, e.g., the surface having the polymers synthesized thereon.

Methods of assembly of a probe array into housing are described in substantial detail in U.S. Pat. No. 5,959,098 and US. Publication No. 2006-0088863, which are hereby incorporated herein by reference in their entirety for all purposes. The fabrication of arrays of polymers, such as nucleic acids, on a solid substrate, and methods of use of the arrays in different assays, are also described in: U.S. Pat. Nos. 5,744,101, 5,677,195, 5,624,711, 5,599,695, 5,445,934, 5,451,683, 5,424,186, 5,412,087, 5,405,783, 5,384,261, 5,252,743 and 5,143,854; PCT WO 92/10092, which are all hereby incorporated herein by reference in their entirety for all purposes.

### VI. Applications Using Nucleic Acid Arrays

A variety of applications using nucleic acid arrays are described in U.S. Pat. No. 7,005,259, which is hereby incorporated herein by reference in its entirety for all purposes.

The methods and compositions described herein may be used in a range of applications including biomedical and genetic research as well as clinical diagnostics. Arrays of polymers such as nucleic acids may be screened for specific binding to a target, such as a complementary nucleotide, for example, in screening studies for determination of binding affinity and in diagnostic assays. In one embodiment, sequencing of polynucleotides can be conducted, as disclosed in U.S. Pat. No. 5,547,839. The nucleic acid arrays may be used in many other applications including detection of genetic diseases such as cystic fibrosis, diabetes, and acquired diseases such as cancer, as disclosed in U.S. patent application Ser. No. 08/143,312 (abandoned). Genetic mutations may be detected by sequencing by hydridization. In one embodiment, genetic markers may be sequenced and mapped using Type-IIs restriction endonucleases as disclosed in U.S. Pat. No. 5,710,000.

Other applications include chip based genotyping, species identification and phenotypic characterization, as described in U.S. Pat. No. 6,228,575 and U.S. patent application Ser. No. 08/629,031 (abandoned), filed Apr. 8, 1996. Still other applications are described in U.S. Pat. No. 5,800,992.

Gene expression may be monitored by hybridization of large numbers of mRNAs in parallel using high density arrays of nucleic acids in cells, such as in microorganisms such as yeast, as described in Lockhart et al., Nature Biotechnology, 14:1675 1680 (1996). Bacterial transcript imaging by hybridization of total RNA to nucleic acid arrays may be conducted as described in Saizieu et al., Nature Biotechnology, 16:45 48 (1998). Accessing genetic information using high density DNA arrays is further described in Chee, Science 274:610 614 (1996).

Still other methods for screening target molecules for specific binding to arrays of polymers, such as nucleic acids, immobilized on a solid substrate, are disclosed, for example, in U.S. Pat. No. 5,510,270.

Devices for concurrently processing multiple biological chip assays are useful for each of the applications described above (see, for example, U.S. Patent Application Publication No. US 2006/0088863, which is incorporate by reference in its entirety). Methods and systems for detecting a labeled marker on a sample on a solid support, wherein the labeled material emits radiation at a wavelength that is different from the excitation wavelength, which radiation is collected by collection optics and imaged onto a detector which generates an image of the sample, are disclosed in U.S. Pat. No. 5,578,832, which is hereby incorporated herein by reference in its entirety for all purposes.

These methods permit a highly sensitive and resolved image to be obtained at high speed. Methods and apparatus for detection of fluorescently labeled materials are further described in U.S. Pat. Nos. 5,631,734 and 5,324,633, which are hereby incorporated herein by reference in their entirety for all purposes.

Typically, in carrying out these methods, the housed substrate is mounted on a hybridization station where it is connected to a fluid delivery system. After hybridization, a rinsing/washing step occurs. Following hybridization and appropriate rinsing/washing, the housed substrate may be aligned on a detection or imaging system. Descriptions of these steps are described in detail in U.S. Pat. No. 5,959,098, which is hereby incorporated herein by reference in its entirety for all purposes.

All publications and patent applications cited above are incorporated by reference in their entirety for all purposes to the same extent as if each individual publication or patent application were specifically and individually indicated to be so incorporated by reference. Although some embodiments of the invention has been described in some detail by way of illustration and example for purposes of clarity and understanding, it will be apparent that certain changes and modifications may be practiced within the scope of the appended claims.

What is claimed is:

1. A method of preparing a plurality of polymer arrays on a surface of a plurality of substrates, the method comprising:
(a) providing a substrate A having a first surface and a substrate B having a second surface, wherein the first surface of substrate A is facing the second surface of substrate B in a reaction chamber;
(b) activating the first surface and the second surface;
(c) simultaneously coupling a monomer to the first surface of substrate A and to the second surface of substrate B in a reaction chamber with a monomer solution, wherein the monomer solution is in contact with the first surface of substrate A and the second surface of substrate B ;
(d) repeating steps (b) and (c) in different selected regions of the first and second surfaces to form a plurality of different polymer sequences in different known locations on the first and second surfaces of substrate A and B.

2. The method according to claim 1, wherein activating comprises directing an activation radiation at the first surface of substrate A and second surface of substrate B.

3. The method according to claim 2, wherein the activation radiation is selected from the group consisting of electron beam radiation, gamma radiation, x-ray radiation, ultra-violet radiation, visible light, and infrared radiation.

4. The method according to claim 1, wherein the first surface and the second surface have reactive functional groups thereon, the reactive functional groups being protected by a protective group.

5. The method according to claim 4, wherein the reactive functional groups are attached to the first and second surfaces via a linker.

6. The method according to claim 4, wherein the protective group is selected from the group consisting of orthonitrobenzyl derivatives, 6-nitroveratryloxycarbonyl, 2-nitrobenzyloxycarbonyl, alpha, alpha-dimethyl-dimethoxybenzyloxycarbonyl, o-hydroxy-alpha-methyl cinnamoyl derivatives and mixtures thereof.

7. The method according to claim 1, wherein the method further comprises rotating the reaction chamber to mix the monomer solution during the activating step.

8. The method according to claim 7, wherein the substrate is glass.

9. The method according to claim 1, wherein activation comprises using a mask having transparent locations and opaque locations to direct light at the selected locations.

10. The method according to claim 1, wherein the polymer sequences comprise nucleic acid sequences, and the monomers in the reaction fluids comprise nucleotides.

11. The method according to claim 1, wherein the polymer sequences comprise polypeptide sequences, and the monomers in the reaction fluids comprise amino acids.

12. A system for synthesizing a plurality of monomers on a plurality of substrates comprising:
a reaction chamber;
a system for delivering reaction fluids containing selected monomers to the reaction chamber; and
a substrate A having a first surface;
a substrate B having a second surface, wherein the first and second surfaces are exposed to the reaction fluids in the reaction chamber simultaneously; and
an activating system for activating the first surface of substrate A and the second surface of substrate B.

13. The system according to claim 12, wherein the activating system comprises directing an activation radiation at the first surface of substrate A and second surface of substrate B.

14. The system according to claim 13, wherein the activating system is selected from the group consisting of electron beam radiation, gamma radiation, x-ray radiation, ultra-violet radiation, visible light, and infrared radiation.

15. The system according to claim 12, wherein the first surface and the second surface have reactive functional groups thereon, the reactive functional groups being protected by a protective group.

16. The system according to claim 15, wherein the reactive functional group is attached to the substrate via a linker.

17. The system according to claim 15, wherein the protective group is selected from the group consisting of orthonitrobenzyl derivatives, 6-nitroveratryloxycarbonyl, 2-nitrobenzyloxycarbonyl, alpha, alpha-dimethyl-dimethoxybenzyloxycarbonyl, o-hydroxy-alpha-methyl cinnamoyl derivatives and mixtures thereof.

18. The system according to claim 12, further comprising a means for rotating to mix the reaction fluids during the exposure process to the reaction fluids.

19. The system according to claim 12, wherein the first surface of substrate A is facing towards the second surface of substrate B in the reaction chamber thereby enclosing a cavity within the reaction chamber, the cavity including an inlet for flowing reaction fluids containing monomers into said cavity and an outlet for flowing reaction fluids out of the cavity.

20. The system according to claim 12, wherein the substrate comprises glass.

21. The system according to claim 12, wherein the activation step comprises using a mask having transparent locations and opaque locations to direct light at the selected locations.

22. A method of preparing a plurality of polymer arrays on a surface of a substrate, the method comprising:
(a) providing at least one substrate having a surface;
(b) activating the surface of at least one substrate;
(c) coupling a monomer to the surface of the at least one substrate with a monomer solution in a reaction chamber;
(d) repeating steps (b) and (c) in different selected regions of the surface to form a plurality of different polymer sequences in different known locations on the surface of the substrate;
(e) using the monomer solution to activate a surface of a different substrate by repeating steps (a) through (d) on the different substrate using the monomer solution.
